(19) United States
(12) Patent Application Publication
(10) Pub. No.: US 2011/0142524 A1
(43) Pub. Date: Jun. 16, 2011

(54) TRANSPORTATION ROLLER, TRANSPORTATION UNIT, PRINTING APPARATUS, AND METHOD OF MANUFACTURING TRANSPORTATION ROLLER

(75) Inventors: Koichi SAITO, Matsumoto-shi (JP); Toru SHINTATE, Komagane-shi (JP); Shinji OKUYAMA, Mikawa-mati (JP); Kenji OZAWA, Shiojiri-shi (JP)

(73) Assignee: SEIKO EPSON CORPORATION, Tokyo (JP)

(21) Appl. No.: 12/962,919

(22) Filed: Dec. 8, 2010

(30) Foreign Application Priority Data
Dec. 16, 2009 (JP) 2009-284878

(51) Int. Cl. B41J 13/02; F16C 13/00; B21K 21/00

(52) U.S. Cl. 400/578; 492/57; 76/101.1

(57) ABSTRACT

Provided is a transportation roller, a transportation unit, a printing apparatus, and a method of manufacturing a transportation roller capable of reducing warpage with the elapsing of time. A transportation roller includes: a roller body which is formed in a cylindrical shape by subjecting a metal sheet to a pressing process and allowing a pair of end portions thereof to face each other, and has a joint formed between the pair of end portions, wherein in a sectional shape perpendicular to the axis of the roller body, a thickness of a joint facing portion facing the joint with the axis interposed therebetween is larger than a thickness of a joint portion provided with the joint, and a thickness of the roller body connecting the joint facing portion and the joint portion is gradually changed as it goes from the joint facing portion to the joint portion.

### CROSS-REFERENCE TO RELATED APPLICATIONS

This application claims the benefit of priority to Japanese Patent Application No. 2009-284878 filed Dec. 16, 2009, the contents of which are hereby incorporated by reference in their entirety.

### BACKGROUND

1. Technical Field

The present invention relates to a transportation roller, a transportation unit, a printing apparatus, and a method of manufacturing a transportation roller.

2. Related Art

For some time, a printing apparatus for printing information on a sheet-like printing medium has been used, and the printing apparatus includes a transportation unit that transports the printing medium as a transportation target. The transportation unit includes a transportation roller that is used to transport the printing medium. A solid round bar member is generally used as the transportation roller. The printing medium is held by the transportation roller, and is transported when the transportation roller is rotated. In addition, since a printing process is performed on the printing medium along with the transportation, the printing medium needs to be transported with high positioning precision in order to perform an appropriate printing process.

Meanwhile, since the solid member causes an increase in the weight and cost, a method of decreasing the weight and the cost has been examined. Here, JP-A-2006-289496 discloses a technology that manufactures a hollow cylindrical shaft in such a manner that a metal sheet is pressed to be bent, and a pair of end portions thereof faces each other.

Here, in order to transport the printing medium with high positioning precision, the cylindrical shaft needs to have high circularity and excellent linearity with small warpage in the axial direction.

However, even when the cylindrical shaft has excellent linearity at the manufacturing stage, warpage may occur with the elapsing of time, and the transportation performance may be degraded. In the cylindrical shaft, a convex warpage occurs in the joint formed by a pair of facing end portions of the metal sheet in accordance with a variation in time.

It is supposed that the warpage occurs in the cylindrical shaft in accordance with a variation in time due to such reasons that various processes are performed on the joint so as to improve the circularity at the manufacturing stage, and the internal stress accumulated in that portion causing extension in the axial direction escapes in accordance with the elapsing of time.

For example, in order to allow the pair of end portions of the metal sheet to come into contact with each other without a gap therebetween, a pressing process can be performed in such a manner that the pair of end portions is aligned with each other, and is crushed in the circumferential direction. However, in this case, the crushing margin escapes in the axial direction, thereby generating the internal stress causing extension in the axial direction in the joint portion.

Further, for example, as disclosed in JP-A-2006-289496, when a concave portion and a convex portion are respectively formed in the pair of end portions of the metal sheet, and the convex portion is press-inserted into the concave portion while the pair of end portions face each other, the internal stress causing extension in the axial direction is generated in the joint portion.

Furthermore, for example, in order to allow the pair of end portions of the metal sheet to come into contact with each other without a gap therebetween, when the pair of end portions is subjected to a pressing process in advance to be formed in a taper shape having a predetermined angle, the internal stress is accumulated in the pair of end portions. In this state, when the pair of end portions faces each other, the internal stress causing extension in the axial direction is generated in the joint portion.

### SUMMARY

An advantage of some aspects of the invention is that it provides a transportation roller, a transportation unit, a printing apparatus, and a method of manufacturing a transportation roller capable of reducing warpage with the elapsing of time.

In order to solve the above-described problems, according to an aspect of the invention, there is provided a transportation roller including: a cylindrical shaft which is formed in a cylindrical shape by subjecting a metal sheet to a pressing process and allowing a pair of end portions thereof to face each other, and has a joint formed between the pair of end portions, wherein in a sectional shape perpendicular to the axis of the cylindrical shaft, a thickness of a joint facing portion facing the joint with the axis interposed therebetween is larger than a thickness of a joint portion provided with the joint, and a thickness of the cylindrical shaft connecting the joint facing portion and the joint portion is gradually changed as it goes from the joint facing portion to the joint portion.

By adopting such a configuration, in the sectional shape perpendicular to the axis of the cylindrical shaft, when the thickness of the joint facing portion is larger than the thickness of the joint portion, the thickness of the joint portion becomes relatively small. Since the joint portion is the portion where the internal stress causing extension in the axial direction is accumulated, when the thickness of the joint portion is decreased, it is possible to reduce the internal stress, and to reduce the convex warpage occurring in the joint portion extending in the axial direction. In addition, even when the joint portion attempts to extend in the axial direction due to the internal stress, since the thickness of the joint facing portion is relatively large, it is possible to suppress the deformation. Further, since the thickness is gradually changed from the joint facing portion to the joint portion, it is possible to prevent the interference of the power transmission or the occurrence of stress concentration caused by the local step therebetween, and to prevent the occurrence of the warpage of the cylindrical shaft and distortion degrading the circularity.

Further, in the transportation roller of the aspect of the invention, in the sectional shape, the outer diameter shape of the cylindrical shaft may be a circular shape about the axis, and the inner diameter shape of the cylindrical shaft may be a circular shape deviating from the axis to the joint portion.

By adopting such a configuration, since the circular shape of the inner diameter shape deviates to the joint portion with respect to the circular shape of the outer diameter shape, it is possible to form the thickness of the joint facing portion to be larger than the thickness of the joint portion, and to gradually change the thickness from the joint facing portion to the joint portion.

Further, according to another aspect of the invention, there is provided a transportation unit including: the transportation roller; and a driving device which rotationally drives the transportation roller.

By adopting such a configuration, since the transportation roller has small warpage with the elapsing of time, it is possible to accurately transport the printing medium for a longer period of time.

Further, according to still another aspect of the invention, there is provided a printing apparatus including: the transportation unit; and a printing unit which performs a printing process on a printing medium transported by the transportation unit.

By adopting such a configuration, since the printing medium can be precisely transported, it is possible to perform an accurate printing process on the printing medium for a longer period of time.

Further, according to still another aspect of the invention, there is provided a method of manufacturing a transportation roller including a cylindrical shaft which is formed in a cylindrical shape by subjecting a metal sheet to a pressing process and allowing a pair of end portions thereof to face each other, and has a joint formed between the pair of end portions, the method including: adjusting a thickness so that in a sectional shape perpendicular to the axis of the cylindrical shaft, a thickness of a joint facing portion facing the joint with the axis interposed therebetween is larger than a thickness of a joint portion provided with the joint, and a thickness of the cylindrical shaft connecting the joint facing portion and the joint portion is gradually changed as it goes from the joint facing portion to the joint portion.

By adopting such a method, it is possible to manufacture the transportation roller in which warpage with the elapsing of time is small.

Further, in the method of the aspect, in the adjusting of the thickness, the cylindrical shaft is formed by subjecting the metal sheet having a predetermined sheet thickness to the pressing process and allowing the pair of end portions thereof to face each other, and the joint is formed between the pair of end portions. The method further includes: cutting the outer peripheral surface of the cylindrical shaft on the side of the joint portion by the predetermined thickness in accordance with a difference between the thickness of the joint facing portion and the thickness of the joint portion; and grinding the outer peripheral surface of the cut cylindrical shaft.

By adopting such a method, the cylindrical shaft having a predetermined thickness is formed by a pressing process, and then the outer peripheral surface on the side corresponding to the joint portion of the cylindrical shaft is cut by a predetermined thickness. Accordingly, the outer diameter shape of the cylindrical shaft is changed from the cylindrical shape, but the inner diameter shape of the cylindrical shaft is maintained in the circular shape. Then, when the cylindrical shaft is subjected to the centerless grinding process, the outer diameter shape of the cylindrical shaft is gradually processed into a circular shape. However, since the side corresponding to the joint portion is cut by a predetermined thickness, the circular shape of the inner diameter shape deviates to the joint portion with respect to the circular shape of the outer diameter shape. Accordingly, it is possible to form the thickness of the joint facing portion to be larger than the thickness of the joint portion, and to gradually change the thickness from the joint facing portion to the joint portion.

### BRIEF DESCRIPTION OF THE DRAWINGS

The invention will be described with reference to the accompanying drawings, wherein like numbers reference like elements.

FIG. 1 is a side cross-sectional view illustrating an ink jet printer according to the embodiment of the invention.

FIG. 2A is a plan view illustrating a transportation roller mechanism, and FIG. 2B is a side view illustrating a driving system.

FIG. 3A is a schematic configuration diagram illustrating the transportation roller mechanism, and FIG. 3B is a schematic configuration diagram illustrating a bearing.

FIG. 4 is an enlarged view illustrating a configuration of the transportation roller according to the embodiment of the invention.

FIG. 5 is a cross-sectional view taken along the line V-V of FIG. 4.

FIG. 6 is a schematic configuration diagram illustrating a device for manufacturing the transportation roller according to the embodiment of the invention.

FIGS. 7A and 7B are process diagrams illustrating a punching process according to the embodiment of the invention.

FIG. 8 is a plan view illustrating a metal sheet which has been subjected to the punching process according to the embodiment of the invention.

FIGS. 9A to 9C are process diagrams illustrating a bending process.

FIGS. 10A to 10C are process diagrams illustrating a bending process.

FIG. 11 is a cross-sectional view illustrating a roller body which has been subjected to a cutting process according to the embodiment of the invention.

FIG. 12 is a process diagram illustrating a centerless grinding process according to the embodiment of the invention.

FIG. 13 is a schematic configuration diagram illustrating a coating booth for forming a high friction layer according to the embodiment of the invention.

FIGS. 14A to 14D are schematic diagrams illustrating a configuration of the roller body.

FIGS. 15A to 15C are schematic diagrams illustrating a configuration of the roller body.

FIG. 16A is a perspective view illustrating a main part of the roller body, and FIG. 16B is a side cross-sectional view illustrating the same.

FIG. 17A is a perspective view illustrating a main part of the roller body, and FIG. 17B is a side view illustrating the same.

FIG. 18A is a perspective view illustrating a main part of the roller body, and FIG. 18B is a side view illustrating the same.

FIG. 19A is a perspective view illustrating a main part of the roller body, and FIG. 19B is a side view illustrating the same.

FIGS. 20A to 20D are plan views illustrating a main part of a metal sheet showing a development engagement portion.

FIGS. 21A to 21C are plan views illustrating a main part of the metal sheet showing a development engagement portion.

FIG. 22A is a diagram illustrating a joint of the roller body, and FIG. 22B is a plan view illustrating the metal sheet.

FIG. 23A is a diagram illustrating the joint of the roller body, and FIG. 23B is a plan view illustrating the metal sheet.

FIG. 24 is a perspective view illustrating a relationship between the transportation roller and the sheet during the sheet transportation.

FIGS. 25A to 25C are diagrams illustrating the shape of the joint.

FIGS. 26A to 26C are diagrams illustrating the shape of the joint.

### DESCRIPTION OF EXEMPLARY EMBODIMENTS

Hereinafter, exemplary embodiments of the invention will be described with reference to the accompanying drawings.

Further, in the drawings which will be used for the following description, the scales of the respective members are appropriately changed so that the respective members have recognizable sizes.

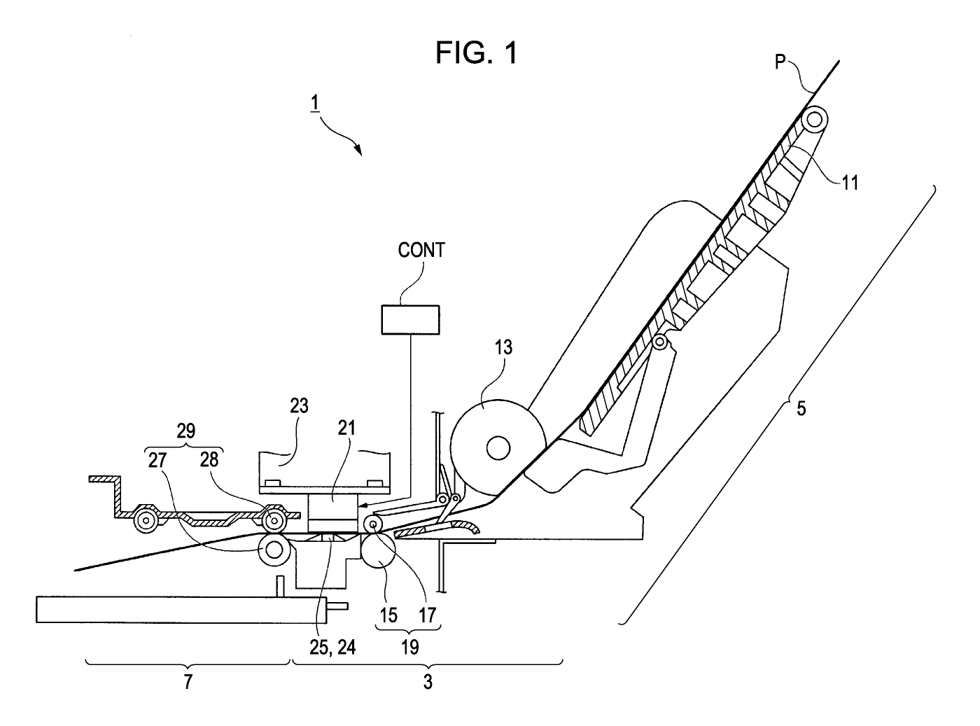

FIG. 1 is a side cross-sectional view illustrating an ink jet printer according to the embodiment of the invention.

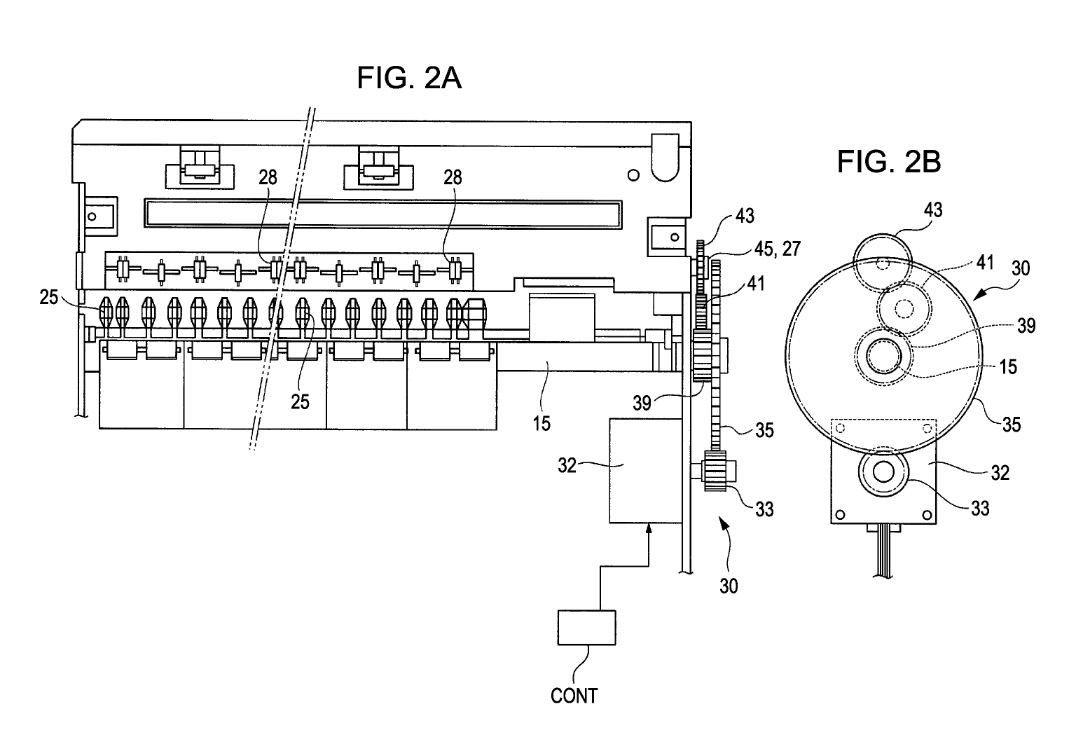

FIG. 2A is a plan view illustrating a transportation roller mechanism of the ink jet printer, and

FIG. 2B is a side view illustrating a driving system of the transportation roller mechanism.

As shown in FIG. 1, an ink jet printer (printing apparatus) 1 includes a printer body 3; a sheet feeding unit 5 which is provided in the rear upper portion of the printer body 3; and a sheet discharging unit 7 which is provided in front of the printer body 3.

A sheet feeding tray 11 is provided in the sheet feeding unit 5, and a plurality of sheets (mediums, printing mediums, or transportation mediums) P is stacked in the sheet feeding tray 11. Here, examples of the sheet P include a normal sheet, a coating sheet, a sheet for an OHP (overhead projector), a glossy sheet, a glossy film, and the like. Hereinafter, the side of the sheet feeding tray 11 in the transportation path of the sheet P is set to the upstream side, and the side of the sheet discharging unit 7 is set to the downstream side. A sheet feeding roller 13 is provided on the downstream side of the sheet feeding tray 11.

The sheet feeding roller 13 is adapted to pinch the sheet P located at the uppermost position of the sheet feeding tray 11 between the sheet feeding roller 13 and a facing separation pad (not shown), and to send the sheet P to the downstream side. A transportation roller mechanism 19 is provided on the downstream side of the sheet feeding roller 13.

The transportation roller mechanism 19 includes a transportation roller 15 disposed on the lower side, and a driven roller 17 disposed on the upper side.

The transportation roller 15 is adapted to pinch the sheet P between the transportation roller 15 and the driven roller 17, and to be rotationally driven by a driving unit (driving device) 30 (refer to FIG. 2). Accordingly, the transportation roller 15 is adapted to accurately and precisely transport the sheet P to a printing head (printing unit) 21 disposed on the downstream side in accordance with a printing process.

The printing head 21 is held by a carriage 23, and the carriage 23 is adapted to reciprocate in a direction perpendicular to the sheet feeding direction (the transportation direction of the sheet P). The printing process using the printing head 21 is controlled by a control unit CONT. A platen 24 is disposed at a position facing the printing head 21.

The platen 24 is constituted by a plurality of diamond ribs 25 arranged at an interval along the movement direction of the carriage 23.

The diamond rib 25 is used to support the lower side of the sheet P when performing a printing process on the sheet P using the printing head 21, and its top surface serves as a support surface. The distance between the diamond rib 25 and the printing head 21 is adjustable in accordance with the thickness of the sheet P. Accordingly, the sheet P can smoothly pass through the top surface of the diamond rib 25. A sheet discharging roller mechanism 29 is provided on the downstream side of the diamond rib 25 and the printing head 21.

The sheet discharging roller mechanism 29 includes a sheet discharging roller 27 disposed on the lower side, and a sheet discharging knurled roller 28 disposed on the upper side, where the sheet P is drawn and discharged by the rotational driving operation of the sheet discharging roller 27.

Here, a relationship between the driving speeds of the driving unit 30, the transportation roller 15, and the sheet discharging roller 27 of the transportation roller mechanism 19 and the sheet discharging roller mechanism 29 will be described.

As shown in FIGS. 2A and 2B, the printer body 3 is provided with a transportation motor 32 that is driven under the control of the control unit CONT. The driving shaft of the transportation motor 32 is provided with a pinion 33, where the pinion 33 meshes with the transportation driving gear 35, and the transportation roller 15 is inserted and connected to the inside of the transportation driving gear 35.

The transportation motor 32 and the like with the above-described configuration constitute the driving unit 30 that rotationally drives the transportation roller 15.

In addition, the transportation roller 15 is provided with an inner gear 39 that is coaxial with the transportation driving gear 35, where a middle gear 41 meshes with the inner gear 39, and a sheet discharging driving gear 43 meshes with the middle gear 41. The rotation shaft of the sheet discharging driving gear 43 serves as a shaft body 45 of the sheet discharging roller 27 as shown in FIG. 2A.

With the above-described configuration, the transportation roller 15 of the transportation roller mechanism 19 and the sheet discharging roller 27 of the sheet discharging roller mechanism 29 are adapted to be driven by receiving the rotational driving force transmitted from the transportation motor 32 as the common driving source.

Further, the rotation speed of the sheet discharging roller 27 is set to be faster than the rotation speed of the transportation roller 15 by adjusting the gear ratio of the gears. Accordingly, only the acceleration rate of the sheet discharging speed of the sheet discharging roller mechanism 29 becomes faster than that of the transportation roller mechanism 19.

Furthermore, the pinching force (pressing force) applied from the transportation roller mechanism 19 to the sheet P is set to be larger than the pinching force (pressing force) applied from the sheet discharging roller mechanism 29. Accordingly, when both the transportation roller mechanism 19 and the sheet discharging roller mechanism 29 pinch the sheet P, the sheet transportation speed is regulated by the transportation speed of the transportation roller mechanism 19 regardless of the sheet discharging speed of the sheet discharging roller mechanism 29.

Next, the transportation roller 15 and the transportation roller mechanism 19 having the same will be described.

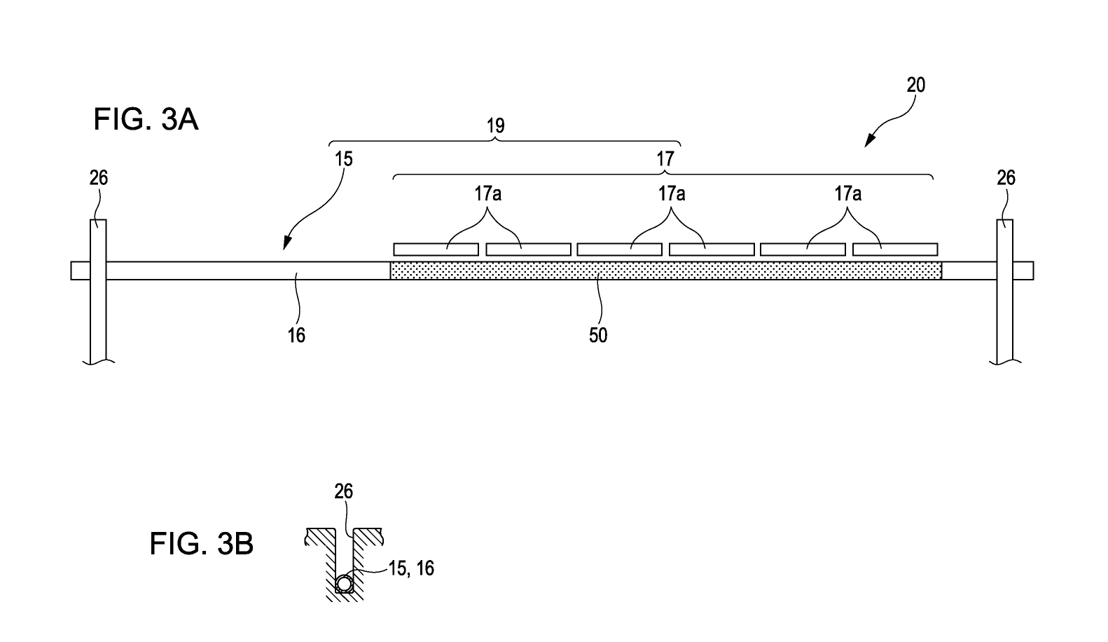

FIG. 3A is a schematic configuration diagram illustrating the transportation roller mechanism 19, and FIG. 3B is a schematic configuration diagram illustrating a bearing.

The transportation roller 15 includes a roller body (cylindrical shaft) 16 having a hollow cylindrical shape and a high friction layer (medium support area) 50 formed on a part of a surface of the roller body 16 in the longitudinal direction (axial direction).

As shown in FIG. 3A, the high friction layer 50 is selectively formed at the center portion of the roller body 16 except for both end portions thereof. Since sharp and pointed portions of inorganic particles are exposed and fixed on the surface of the high friction layer 50, a high friction force is exhibited.

The high friction layer 50 is formed in such a manner that a resinous film is formed by selectively applying resinous particles to the high friction layer formation area of the surface of the roller body 16 to have a uniform film thickness of, for example, 10 μm to 30 μm, inorganic particles are uniformly sprayed onto the resinous film, and the resinous film having the inorganic particles thereon is baked at a high temperature. As the resinous particles, for example, minute particles of epoxy-based resin or polyester-based resin each having a diameter of about 10 to 20 μm are preferably used. Further, as the inorganic particles, ceramics particles such as aluminum oxide (alumina; Al₂O₃), silicon carbide (SiC), or silicon dioxide (SiO₂) adjusted to have a predetermined particle diameter via a crushing process are preferably used.

As shown in FIG. 3A, the transportation roller 15 is rotatably supported by a bearing 26 of which both end portions are integrally formed with the platen 24 (refer to FIG. 1). As shown in FIG. 3B, the bearing 26 is formed in a U-shape of which the upper portion is opened, and axially supports the transportation roller 15 in a direction from the front rear side and the lower side thereof by fitting the transportation roller 15 into the U-shaped portion. In addition, lubricating oil (lubricating fluid) such as grease is applied to the contact surface (the surface of the transportation roller 15) between the bearing 26 and the transportation roller 15. Further, one end or both ends of the transportation roller 15 is provided with an engagement portion (not shown) that is used for the immovable engagement and connection with the inner gear 39 or transportation driving gear 35. The transportation roller 15 is provided with various forms of engagement portions that are used for the connection with various connection components.

The driven roller 17 is formed by coaxially arranging a plurality of (for example, six) rollers 17a, and is disposed at a position facing and coming into contact with the high friction layer 50 of the transportation roller 15. An urging spring (not shown) is attached to the driven roller 17 including the rollers 17a, and hence the driven roller 17 is urged toward the transportation roller 15.

Accordingly, the driven roller 17 comes into contact with the high friction layer 50 of the transportation roller 15 at a predetermined pressing force (a pinching force for the sheet P), and is rotated with the rotation operation of the transportation roller 15. Further, since the force for pinching the sheet P between the transportation roller 15 and the driven roller 17 is large, the sheet P is more satisfactorily transported.

In addition, the surface of each roller 17a of the driven roller 17 is subjected to a low abrasion process such as coating of, for example, a fluororesin or the like in order to alleviate the damage caused by the contact with respect to the high friction layer 50.

The transportation roller 15, the bearing 26, the driving unit 30, the driven roller 17, and the like constitute the transportation unit 20 of the ink jet printer 1.

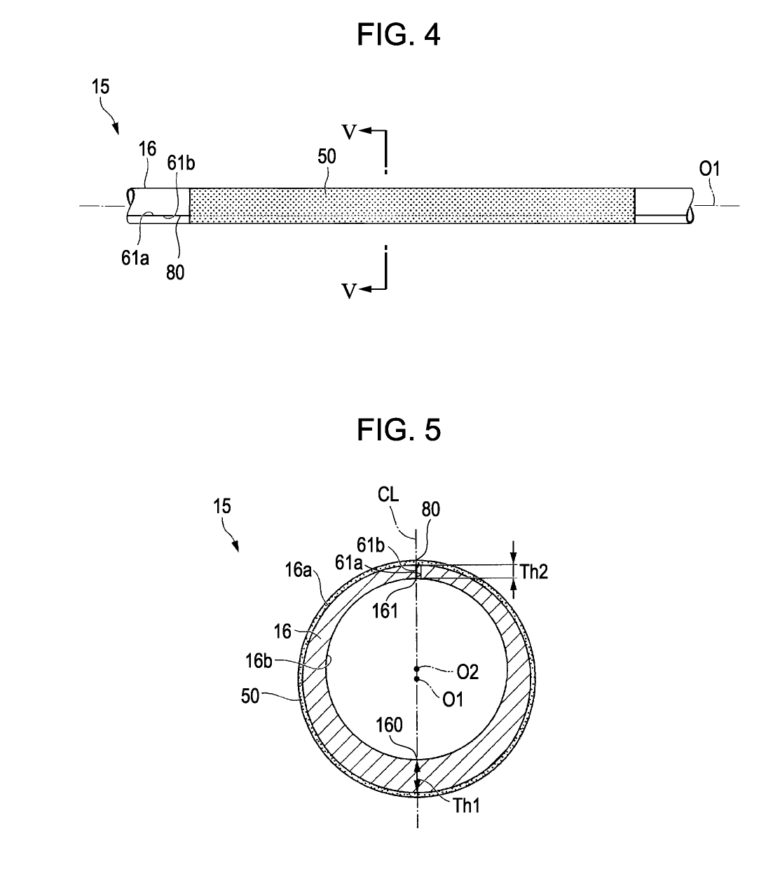

FIG. 4 is an enlarged view illustrating a configuration of the transportation roller 15. FIG. 5 is a cross-sectional view taken along the line V-V of FIG. 4.

The roller body 16 is formed by using a steel sheet coil, obtained by winding a metal sheet such as a zinc plating steel sheet or a stainless steel sheet, as a base material. The roller body 16 is a cylindrical shaft which is subjected to a bending process so that a pair of end portions 61a and 61b of the metal sheet obtained by rewinding a coil through a pressing process to be described later faces each other, and in which the surface on the side of the inner peripheral surface of the coil is used as the inner peripheral surface. That is, the metal sheet forming the roller body 16 is formed in a cylindrical shape so that the wound shape is formed by bending its inner peripheral surface.

The roller body 16 includes a joint 80 which is formed between the pair of end portions 61a and 61b of the metal sheet, where the pair of end portions comes into contact with each other by a bending process as shown in FIG. 4. In addition, the circumferential direction (bending direction) of the roller body 16 of the embodiment is equal to the coil winding direction (the metal sheet rolling direction), and the joint 80 is formed to be substantially parallel to the axial direction of the roller body 16.

FIG. 5 illustrates a sectional shape perpendicular to the axis O1 of the roller body 16. In the sectional shape of the roller body 16 shown in FIG. 5, the thickness Th1 of a joint facing portion 160 facing the joint 80 with the axis O1 interposed therebetween is set to be larger than the thickness Th2 of a joint portion 161 provided with the joint 80. That is, a relationship Th1>Th2 is established.

Further, the joint facing portion 160 and the joint portion 161 indicate a specific portion of the roller body 16 in a predetermined area where they face each other in the line CL passing through the joint 80 and the axis O1.

Further, in the sectional shape, the thickness of the roller body 16 connecting the joint facing portion 160 and the joint portion 161 is set to be gradually changed as it goes from the joint facing portion 160 to the joint portion 161. That is, the thickness of the roller body 16 is continuously decreased toward both sides in the circumferential direction from the thickness Th1 to the thickness Th2.

In the embodiment, in the sectional shape shown in FIG. 5, the outer diameter shape (the shape of the outer peripheral surface 16a) of the roller body 16 is a circular shape about the axis O1. In addition, in the sectional shape shown in FIG. 5, the inner diameter shape (the shape of the inner peripheral surface 16b) of the roller body 16 is a circular shape that deviates from the axis O1 to the joint portion 161 by a predetermined distance. The axis O2 of the inner diameter shape of the roller body 16 moves from the axis O1 to the joint portion 161 by a predetermined distance in the line CL passing through the joint 80 and the axis O1.

The roller body 16 of the embodiment has a line symmetrical shape with respect to the line CL in the sectional shape shown in FIG. 5.

A difference between the thickness Th1 of the joint facing portion 160 and the thickness Th2 of the joint portion 161 is set within a range equal to or more than 10% and equal to or less than 50% when the thickness Th1 is set to 100%. When the thickness Th1 of the joint facing portion 160 is 1.00 mm, the difference between the thickness Th1 and the thickness Th2 is within the range equal to or more than 0.10 mm and equal to or less than 0.50 mm.

Specifically, in the example of the embodiment, a difference between the thickness Th1 and the thickness Th2 is set to 0.15 mm which is a difference in the thickness of 15%. That is, the thickness Th1 is set to 1.00 mm, and the thickness Th2 is set to 0.85 mm.

Next, a device for manufacturing the transportation roller 15 with the above-described configuration will be described.

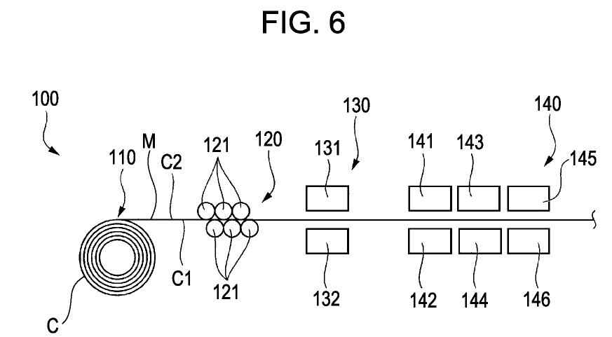

FIG. 6 is a schematic configuration diagram illustrating a device for manufacturing the transportation roller 15 according to the embodiment of the invention.

As shown in FIG. 6, a manufacturing device 100 includes an uncoiler 110, a leveler 120, a first press machine 130, and a second press machine 140 which are disposed in one direction.

Further, the manufacturing device 100 includes a transportation unit (not shown) which sends the metal sheet M rewound from the coil C in one direction, and a cutting unit (not shown) which separates the processed cylindrical shaft (the roller body 16) from the metal sheet M.

The uncoiler 110 is used to rewind the coil C while rotatably supporting the cylindrical coil (steel sheet coil) C, around which the metal sheet M is wound, around the axis.

The leveler 120 includes a plurality of work rolls 121 arranged up and down alternately, and the metal sheet M is flattened in a manner that the metal sheet M passes between the up and down work rolls 121.

The first press machine 130 includes a male (punch) 131 and a female (die) 132, and is adapted to perform a punching process on the metal sheet M into a predetermined shape by pressing.

The second press machine 140 includes a plurality of female (bending dies) 141 and 143 disposed in one direction, a plurality of male (bending punches) 142 and 144 disposed in one direction, an upper die 145, and a lower die 146, and is adapted to perform a bending process on the metal sheet M by pressing. Then, a bending process is sequentially performed on the metal sheet M by different dies while the metal sheet M is intermittently transported in one direction by a transportation unit (not shown) (forward transportation), thereby forming the metal sheet M to gradually have a cylindrical shape.

Next, a method of manufacturing the transportation roller 15 will be described.

First, a coil C is prepared in the rolling direction around which a metal sheet M such as a cold-roll steel sheet or an electrogalvanized steel sheet having, for example, a sheet thickness of about 0.8 mm to 1.2 mm. Then, the coil C is supported by the uncoiler 110 of the manufacturing device 100, and the metal sheet M is rewound by rotating the coil C about the axis. The metal sheet M rewound from the coil C has a circular-arc shape in a side view in which the surface (the lower surface C1) on the side of the inner peripheral surface of the coil C is a concave surface, and the surface (the upper surface C2) on the side of the outer peripheral surface is a convex surface. The rewound metal sheet M is transported in one direction (rolling direction) by the transportation unit (not shown), and reaches the leveler 120.

The metal sheet M reaching the leveler 120 is flattened by the plurality of work rolls 121 disposed up and down, and the wound shape is adjusted. Accordingly, the metal sheet M is flattened up to a degree that the metal sheet M can be processed by the first press machine 130, but the wound shape, in which the surface (the lower surface C1) on the side of the inner peripheral surface of the coil C is a concave surface, is left to a certain degree. The metal sheet M flattened by the leveler 120 is transported in one direction by the transportation unit (not shown), and reaches the first press machine 130.

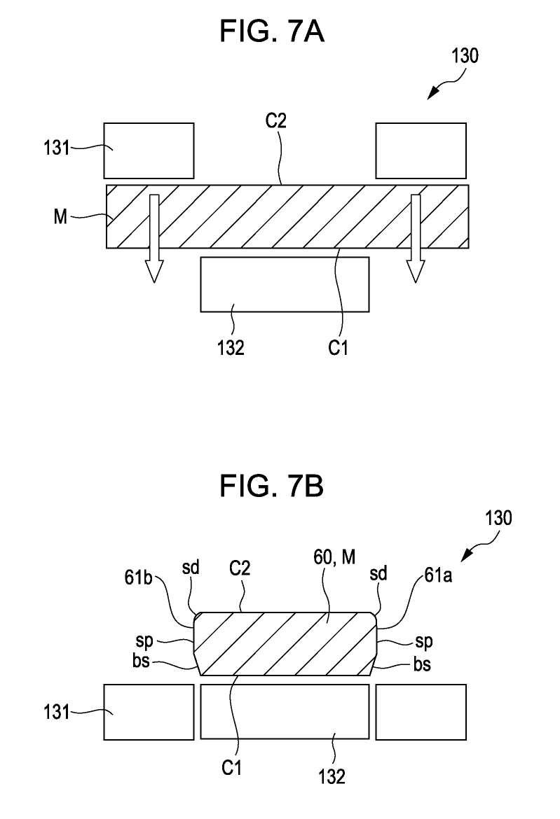

The metal sheet M reaching the first press machine 130 is subjected to a punching process by pressing of the male 131 and the female 132. Then, the metal sheet M punched by the punching process as shown in FIGS. 7A and 7B is used as a base material of the roller body 16. In the subsequent processes, the metal sheet M as the base material of the roller body 16 is subjected to a bending process to have a cylindrical shape in which the upper surface C2 facing the male 131 is the outer peripheral surface 16a as shown in FIG. 7A.

In this case, even when corner sags sd, sheared surfaces sp, broken surfaces bs, burrs (not shown) are formed on the punched metal sheet M as shown in FIG. 7B during the punching process, the upper surface C2 having the comparatively smooth corner sags sd formed thereon is set to the outer peripheral side of the roller body 16. In other words, the lower surface C1 of the metal sheet M continuous to the burrs or the broken surfaces bs is set to the inner peripheral side of the roller body 16.

Accordingly, when the roller body 16 having the joint 80 (refer to FIG. 5) is formed by allowing the pair of end portions 61a and 61b of the metal sheet M to come into contact with each other, it is possible to prevent the joint 80 from being opened due to the interference of the unevenness of the burr or the broken surface bs.

Therefore, it is possible to provide the transportation roller 15 that improves the precision of the joint 80 of the roller body 16 and obtains high transportation precision. In addition, the surface provided with the burr is used as the inner peripheral surface of the roller body 16, and the burr is prevented from protruding from the outer peripheral surface of the roller body 16, thereby improving the productivity by omitting a burr extracting process.

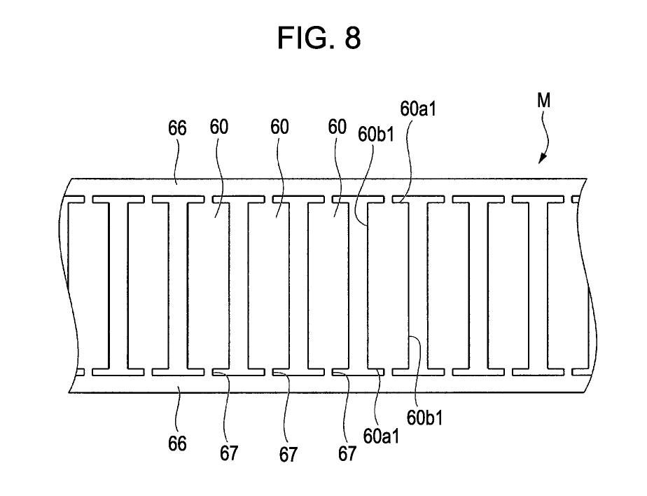

FIG. 8 is a plan view illustrating the metal sheet M which has been subjected to the punching process using the first press machine 130.

As shown in FIG. 8, by the use of a punching process, the metal sheet M is provided with a frame 66 which is continuous in the transportation direction (rolling direction), a band-shaped flat portion 60 which extends in a direction intersecting the transportation direction, and a connection portion 67 which connects the frame 66 and the flat portion 60 to each other. In the embodiment, the flat portion 60 is punched so as to have a substantially rectangular shape, where the short side 60a1 is parallel to the rolling direction, and the long side 60b1 is perpendicular to the rolling direction. When the metal sheet M is repeatedly pressed while being intermittently transmitted by the transportation unit (not shown), a plurality of the flat portions 60 and the connection portions 67 are formed at the same interval in the transportation direction of the metal sheet M.

The metal sheet M subjected to the punching process using the first press machine 130 is transported by the transportation unit (not shown), and reaches the second press machine 140 shown in FIG. 6.

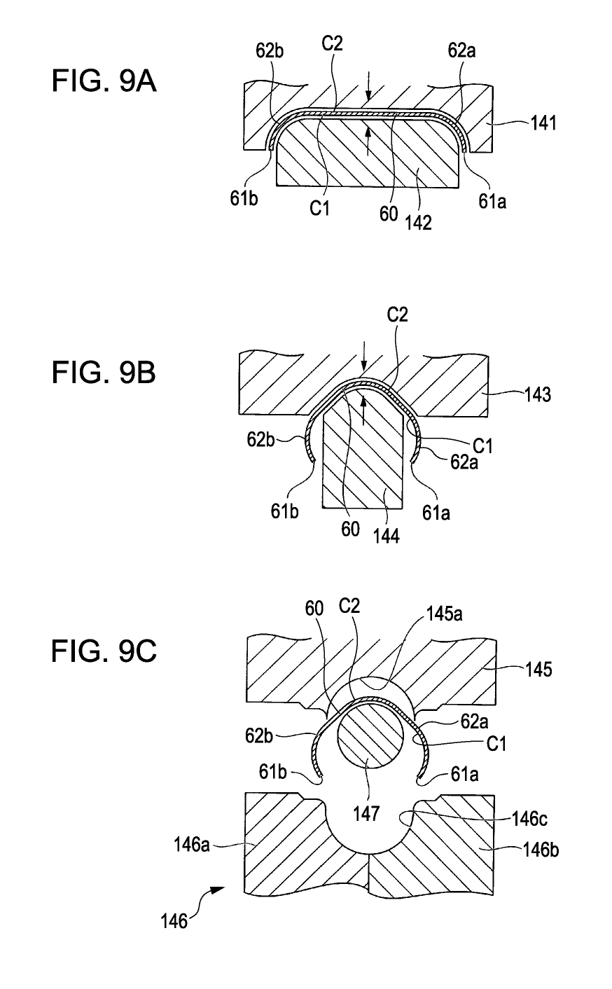

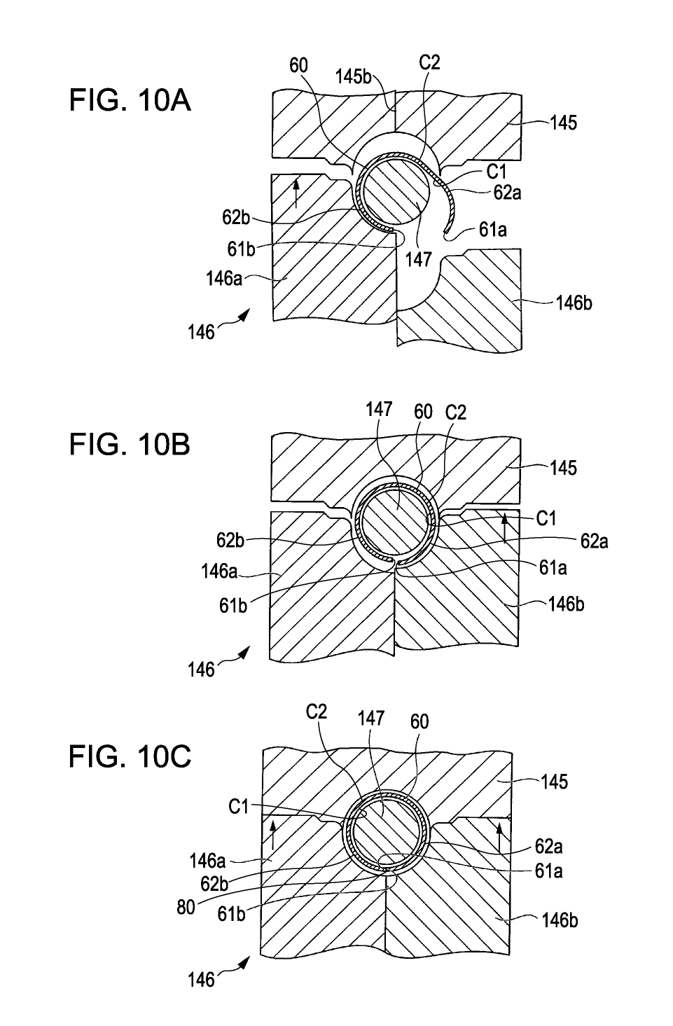

FIGS. 9A to 9C and 10A to 10C are side views illustrating the bending process using the second press machine 140.

The flat portion 60 of the metal sheet M reaching the second press machine 140 is subjected to the bending process in the direction (rolling direction) parallel to the short side 60a1 shown in FIG. 8 by pressing. That is, the bending process is performed so that the end surfaces of a pair of the long sides 60b1 and 60b1 on both sides of the flat portion 60 comes close to each other. That is, as shown in FIGS. 9A to 9C and 10A to 10C, the flat portion 60 is formed in a cylindrical shape so that the pair of end portions 61a and 61b faces and comes into contact with each other.

Specifically, first, the flat portion 60 of the metal sheet M is pressed by the female (bending die) 141 and the male (bending punch) 142 shown in FIG. 9A, and both side portions 62a and 62b of the flat portion 60 are bent in a circular-arc shape (preferably, a substantially ¼ circular arc). Further, in FIG. 9A, the flat portion 60, the female 141, and the male 142 are described as if there is a gap therebetween, but the gap does not exist in fact, and the flat portion 60, the female 141, and the male 142 come into substantially close contact with each other at the contact portion thereof. The same applies to the cases of FIGS. 9B, 9C, and 10A to 10C.

Here, the male 142 is disposed so as to face the lower surface C1 (the lower surface of the flat portion 60 in FIGS. 9A, 9B, and 9C) as the inner peripheral side of the coil C shown in FIG. 6. Further, the female 141 is disposed so as to face the upper surface C2 (the upper surface of the flat portion 60 in FIGS. 9A, 9B, and 9C) as the outer peripheral side of the coil C shown in FIG. 6. Accordingly, both side portions 62a and 62b of the flat portion 60 is bent toward the lower surface C1 as the inner peripheral surface of the coil C.

Subsequently, the metal sheet M is transported in one direction, and then the center portion in the short side direction (bending direction) of the flat portion 60 is pressed by the second female (bending die) 143 and the second male (bending punch) 144 shown in FIG. 9B. Then, the flat portion 60 is bent in a circular-arc shape (preferably, a substantially ¼ circular arc) toward the lower surface C1 at the inner peripheral side of the coil C shown in FIG. 6.

Subsequently, as shown in FIG. 9C, the metal sheet M is transported in one direction, and a cylindrical core die 147 is disposed on the inside of the flat portion 60. Then, both end portions 61a and 61b of both sides portions 62a and 62b of the flat portion 60 come close to each other as shown in FIGS. 10A to 10C by the use of the upper die 145 and the lower die 146 shown in FIG. 9C.

Here, the outer diameter of the core die 147 shown in FIGS. 9C and 10A to 10C is set to be equal to the inner diameter of the roller body 16 having a hollow cylindrical shape. In addition, as shown in FIG. 9C, the radius of a press surface 146c of the lower die 146 and the radius of a press surface 145a of the upper die 145 are set to be equal to the outer diameter of the roller body 16 in consideration of the centerless grinding process to be described later. Further, as shown in FIGS. 10A to 10C, the lower die 146 is formed as a pair of left and right separate dies, and the separate dies 146a and 146b are adapted to be independently elevated.

First, the left separate die 146a in the state shown in FIG. 9C is made to be close to the upper die 145 as shown in FIG. 10A, and one side of the flat portion 60 is subjected to a pressing process so as to be bent in a substantially half circular shape. Further, the upper die 145 is also formed as a pair of left and right separate dies as in the lower die 146 (refer to the separate surface 145b), and the upper die on the same side may be made to be close to the separate die 146a during the process shown in FIG. 10A.

Subsequently, as shown in FIG. 10B, the core die 147 is slightly moved to the upper die 145 (to a degree that one end portion 61a and the other end portion 61b can come close to each other), and the other separate die 146b is made to be close to the upper die 145. Then, the other side of the flat portion 60 is subjected to a pressing process so as to be bent in a substantially half circular shape.

Subsequently, as shown in FIG. 10C, all the core die 147 and the pair of separate dies 146a and 146b are made to be close to the upper die 145, thereby forming the cylindrical roller body (hollow pipe) 16. In this state, both left and right end portions 61a and 61b face and come into contact with each other. That is, in the cylindrical roller body 16, both end portions 61a and 61b of the flat portion 60 of the metal sheet M as the base material come close to each other, and the joint 80 is formed between the end portions 61a and 61b. Here, the lower surface C1 as the inner peripheral side of the coil C shown in FIG. 6 is formed as the inner peripheral surface 16b of the roller body 16, and the surface C2 as the outer peripheral side of the coil C is formed as the outer peripheral surface 16a of the roller body 16. Likewise, the roller body 16 is formed so that the flat portion 60 is wound around the core die 147. After the flat portion 60 is formed in a cylindrical shape, the connection portion 67 is cut by a cutting unit (not shown), thereby forming the cylindrical roller body 16.

In the embodiment, the thickness adjustment of the roller body 16 is performed in order to obtain the sectional shape of the roller body 16 described in FIG. 5 (a thickness adjustment procedure).

Specifically, first, a cutting process is performed on the roller body 16 formed by the pressing process (a cutting procedure). Further, the roller body 16 formed in the pressing process is formed in a cylindrical shape having a substantially uniform thickness. More specifically, the roller body has a shape in which the axes of the outer diameter shape (the shape of the outer peripheral surface 16a) of the roller body 16 and the inner diameter shape (the shape of the inner peripheral surface 16b) of the roller body 16 are aligned to the axis O2 in the sectional shape.

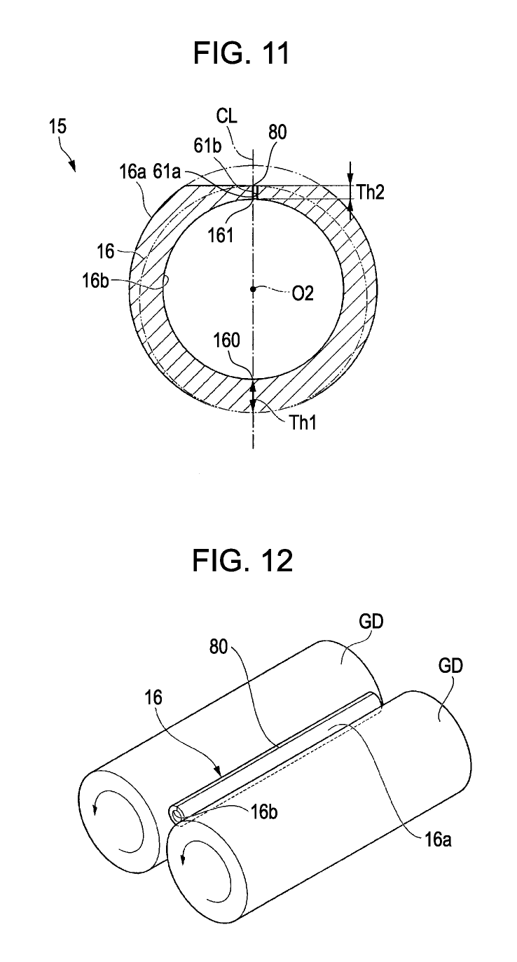

In the cutting procedure, as shown in FIG. 11, the side of the outer peripheral surface 16a corresponding to the joint portion 161 of the roller body 16 is cut by a predetermined thickness by the use of a milling machine or the like. The cutting depth is set in accordance with a difference between the thickness Th1 of the joint facing portion 160 and the thickness Th2 of the joint portion 161 of a final product shown in FIG. 5. Further, the cutting depth is set in consideration of the cutting depth of the centerless grinding process to be described later.

In the cutting procedure, the outer diameter shape of the roller body 16 is formed from a circular shape into an approximate D-shape. Meanwhile, the inner diameter shape of the roller body 16 is formed in a circular shape.

Subsequently, in the embodiment, a centerless grinding process is performed so as to improve circularity of the roller body 16 having a substantially D-shaped outer diameter by the cutting procedure and to reduce rattling (warpage in the axial direction) (a centerless grinding procedure). In the grinding procedure, for example, as shown in FIG. 12, the outer peripheral surface 16a of the roller body 16 is ground by cylindrical grinding stone members GD.

The roller body 16 is disposed between two grinding stone members GD disposed with a gap smaller than the outer diameter of the roller body 16, and the roller body 16 comes into contact with the outer peripheral portions of the two grinding stone members GD. Subsequently, the two grinding stone members GD are rotated, for example, in the same direction. A friction force is generated between the roller body 16 and each of the grinding stone members GD by the rotation of the two grinding stone members GD.

Further, it is desirable to adopt the two grinding stone members GD of which the dimension in the longitudinal direction (the height direction of the cylinder) is larger than the roller body 16 so that the entire roller body 16 in the longitudinal direction can be ground at a time. In addition, it is desirable to dispose the roller body 16 at the center portion in the longitudinal direction of the grinding stone members GD so that, for example, the entire roller body 16 in the longitudinal direction comes into contact with the two grinding stone members GD in order to ensure a margin in the longitudinal direction of the roller body 16 during the rotation of the grinding stone members GD.

In the centerless grinding process, the roller body 16 is rotated in a direction opposite to the rotation direction of the grinding stone members GD by a friction force generated by the rotation of the grinding stone members GD, thereby grinding the outer peripheral surface 16a of the roller body 16. For this reason, substantially the entire surface of the outer peripheral surface 16a of the roller body 16 is thoroughly ground, and the circularity of the roller body 16 is increased compared with the time before the centerless grinding procedure, thereby decreasing the rattling.

Further, in the centerless grinding process, the protrusion portion (the D-shaped corner portion) of the roller body 16 is first ground by the rotation of the grinding stone members GD. For this reason, when the centerless grinding process is performed on the roller body 16 having a substantially D-shaped outer diameter, the cylindrical outer diameter shape is gradually processed so as to be a circular shape. However, since the side corresponding to the joint portion 161 is cut by a predetermined thickness in advance, the circular shape of the inner diameter shape deviates to the joint portion 161 with respect to the circular shape of the outer diameter shape. Accordingly, as shown in FIG. 5, in the sectional shape, the thickness Th1 of the joint facing portion 160 can be made to be larger than the thickness Th2 of the joint portion 161. In addition, the thickness can be gradually changed from the joint facing portion 160 to the joint portion 161.

Likewise, when the roller body 16 as the cylindrical shaft according to the invention is formed, the high friction layer 50 shown in FIG. 3 is formed on the surface of the roller body 16.

As a method of forming the high friction layer 50, a dry method and a wet method (or a method of the combination thereof) can be adopted, but in the embodiment, the dry method is appropriately adopted. Specifically, first, resinous particles and inorganic particles are prepared as the materials for forming the high friction layer 50. As the resinous particles, minute particles each having a diameter of about 10 μm and formed by an epoxy-based resin or a polyester-based resin are preferably used.

Further, as the inorganic particles, ceramics particles such as aluminum oxide (alumina; Al₂O₃), silicon carbide (SiC), or silicon dioxide (SiO₂) are preferably used. Among the examples, the alumina has comparatively high hardness and satisfactorily exhibits a function of increasing friction resistance. Further, due to the comparatively cheap price, it does not become an obstacle to cost reduction. For these reasons, the alumina is more preferably used. Accordingly, in the embodiment, alumina particles are used as the inorganic particles.

As the alumina particles, the alumina particles having a predetermined particle diameter obtained by a crushing process are used. Since the alumina particles are manufactured by the crushing process, the end portions of the alumina particles are comparatively sharp, and a high friction force is exhibited by the sharp and pointed end portions.

Further, as the alumina particles, in the embodiment, alumina particles adjusted to have a particle diameter equal to or more than 15 μm and equal to or less than 90 μm and a particle diameter (average particle diameter) of a weighted average as a center diameter of 45 μm are used.

When the resinous particles and the inorganic particles are prepared, first, the above-described resinous particles are applied to the roller body 16. That is, the roller body 16 is disposed inside a coating booth (not shown), and then the roller body 16 is solely made to have a negative potential.

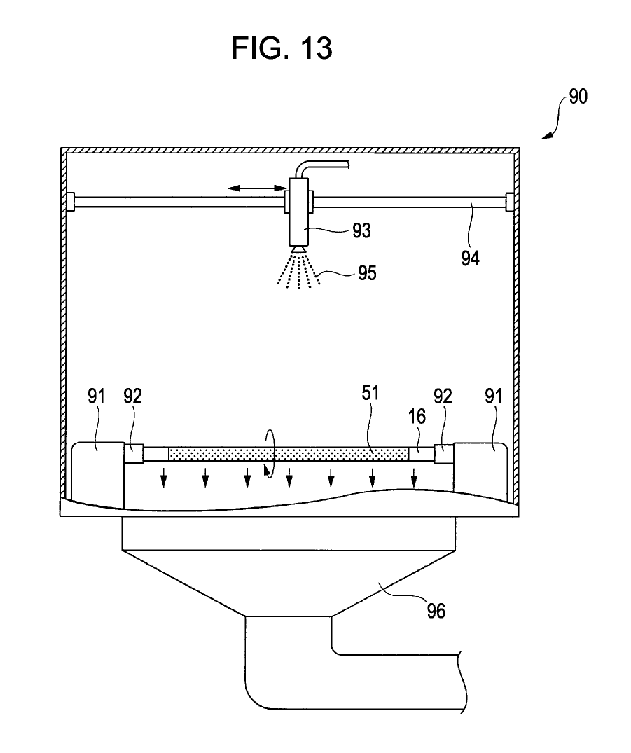

Then, the resinous particles are sprayed toward the roller body 16 by the use of a tribo gun of an electrostatic coating device (not shown), and the sprayed particles (resinous particles) are charged to a positive high potential. Then, the charged resinous particles are absorbed to the outer peripheral surface of the roller body 16, thereby forming a resinous layer 51 (refer to FIG. 13).

Here, the resinous layer 51 formed by the resinous particles using the spray-coating corresponds to the formation area of the high friction layer 50 shown in FIG. 3. That is, the resinous particles are sprayed only to the center portion except for both end portions by masking, for example, both end portions of the roller body 16 by the use of a tape or the like without spraying the resinous particles throughout the entire length of the roller body 16. That is, the resinous layer 51 is selectively formed only in the center portion, which is an area contacting at least the transported sheet P, of the transportation roller 15 formed by the roller body 16.

After the spray-coating, +0.5 KV of a weak static electricity remains in the resinous layer 51. In addition, the resinous layer 51 is formed on the roller body 16 throughout the entire circumference thereof to have a substantially uniform thickness by rotating the roller body 16 about the axis during the spray-coating. The layer thickness of the resinous layer 51 is set to, for example, 10 μm to 30 μm in consideration of the particle diameter of the above-described alumina particles. The layer thickness can be appropriately adjusted in accordance with the spray amount and the spray time of the resinous particles.

Subsequently, the roller body 16 having the resinous layer 51 formed thereon is extracted from the coating booth, and is transferred to another coating booth 90 shown in FIG. 13 by the use of a handling robot (not shown).

The lower portion of the coating booth 90 is provided with a pair of rotation driving members 91, and each of the rotation driving members 91 is provided with a chuck 92 that is used to support the roller body 16 in the substantially horizontal direction.

Then, both end portions of the roller body 16 are respectively held and fixed to the chucks 92, and the chucks 92 are rotated by the rotation driving member 91. Accordingly, the roller body 16 is rotationally driven about the axis at the low speed, for example, equal to or more than 100 rpm and equal to or less than 500 rpm. In addition, the roller body 16 may be, of course, supported in a slightly oblique attitude.

Further, the upper portion of the coating booth 90 is provided with a corona gun 93, and the corona gun 93 is adapted to be movable along a shaft 94 in the left/right direction of FIG. 13. Furthermore, the bottom portion of the coating booth 90 is provided with an exhaust mechanism 96. Accordingly, a slow air stream is formed inside the coating booth 90 toward the lower portion thereof. In addition, the suction wind amount of the exhaust mechanism 96 is appropriately set.

With such a configuration, when the above-described alumina particles 95 are sprayed from the corona gun 93 while rotating the roller body 16 about the axis thereof, the alumina particles 95 are selectively and electrostatically absorbed onto the resinous layer 51 formed on the roller body 16. In order to allow the alumina particles to be selectively and electrostatically absorbed onto the resinous layer 51, both end portions of the roller body 16 may be masked by the use of a tape or the like as in the case of forming the resinous layer 51.

During the electrostatic coating, the surface potentials of the chuck 92 and the rotation driving member 91 are set to be substantially equal to the potential of the roller body 16, and the inner surface potential of the coating booth 90 is set to be substantially 0, that is, the electrical neutral state. This helps the alumina particles 95 sprayed from the corona gun 93 not to be absorbed to a portion other than the roller body 16. In order to maintain the inner surface potential of the coating booth 90 in the electrical neutral state, it is desirable that a steel sheet having an inner surface electrical resistance of, for example, about 10¹¹Ω is used to manufacture the coating booth 90.

Then, the potential applied to the corona gun 93 is set to 0 V, and the pressure of air supplied to the corona gun 93 is set to be low, that is, about 0.2 Mpa. Subsequently, the alumina particles 95 having about 0 potential are blown from the upside while the corona gun 93 is moved in the left/right direction of FIG. 13, the alumina particles 95 are dropped naturally in the vertical direction by gravity.

Then, as described above, since a weak static electricity (about +0.5 KV) formed by the electrostatic coating remains in the resinous layer 51 of the roller body 16, the alumina particles 95 are substantially uniformly absorbed to the entire circumference of the resinous layer 51 by the static electricity. The electrostatically absorbed alumina particles 95 come into contact with the surface of the resinous layer 51, and are attached to the outer peripheral surface of the roller body 16 by using the resinous layer 51 as a binder while being partly absorbed thereto.

Here, in the embodiment, since the inner surface potential of the coating booth 90 is set to be about 0, that is, the electrical neutral state, and the air stream inside the coating booth 90 is formed to be slow to be directed to the downside, the alumina particles 95 are naturally dropped in the vertical direction by the weight. Since the horizontally supported roller body 16 slowly rotates about the axis at the lower portion in the drop direction, the alumina particles 95 are substantially uniformly sprayed to the outer peripheral surface of the roller body 16.

Accordingly, the alumina particles 95 are uniformly attached particularly to the unmasked surface of the resinous layer 51, and the alumina particles (inorganic particles) 95 are dispersed and exposed in the resinous layer 51. That is, a proportion of the alumina particles 95 enters the resinous layer 51 when coming into contact with the resinous layer 51 by the electrostatic absorbing force, and the remainder thereof protrudes from the surface of the resinous layer 51. At this time, since the alumina particles 95 are easily in the attitude perpendicular to the surface of the roller body 16, the alumina particles 95 are uniformly distributed thereon, and most of them are attached thereto while the sharp and pointed end portions (top portions) face outward.

Accordingly, the alumina particles 95 exhibit a high friction force by the use of the end portions protruding from the surface of the resinous layer 51. Here, in order for the alumina particles 95 to exhibit the demanded or sufficient friction force with respect to the sheet P, it is desirable that the area of the alumina particles 95 with respect to the area of the resinous layer 51 is equal to or more than 20% and equal to or less than 80%.

Further, the coating (spraying) method of the alumina particles 95 is not limited to the electrostatic coating method as long as the alumina particles 95 are slowly sprayed downward in the vertical direction. For example, a coating (spraying) method using a sprayer may be used.

Likewise, when the alumina particles 95 are sprayed and attached onto the resinous layer 51, the roller body 16 is heated, and the resinous layer 51 is baked and hardened at the high temperature. By this heating, the alumina particles 95 are fixed to the roller body 16. Accordingly, it is possible to obtain the transportation roller 15 (refer to FIG. 3) having the high friction layer 50 in which the alumina particles (inorganic particles) 95 are dispersed and exposed in the resinous layer 51.

Further, in the embodiment, the coating (spray-coating) of the resinous particles and the coating (spray-coating) of the alumina particles (inorganic particles) are performed in different coating booths, but may be, of course, performed in the same coating booth.

Next, the operation of the ink jet printer 1 with the above-described configuration and the effect of the transportation roller 15 with the above-described configuration will be described.

As shown in FIG. 1, the ink jet printer 1 pinches the sheet P located at the uppermost position of the sheet feeding tray 11 by the use of the sheet feeding roller 13, and transports the sheet P toward the downstream side. The transported sheet P reaches the transportation roller mechanism 19. The transportation roller mechanism 19 pinches the sheet P between the transportation roller 15 and the driven roller 17, and transports the sheet P at a constant speed toward a position below the printing head 21 in accordance with a sheet transportation operation performed by the rotational driving operation of the transportation roller 15. The printing head 21 performs a high-quality printing process on the sheet P transported to the position below the printing head 21 while the sheet P smoothly passes on the top surface of the diamond rib 25. The sheet P printed by the printing head 21 is sequentially discharged by the sheet discharging roller 27 of the sheet discharging unit 7.

Since the transportation speed of the sheet discharging roller mechanism 29 is set to be faster than the transportation speed of the transportation roller mechanism 19, the sheet P is transported in a back tension state. However, when both the transportation roller mechanism 19 and the sheet discharging roller mechanism 29 pinch the sheet P, the sheet transportation speed is set to the transportation speed of the transportation roller mechanism 19. Accordingly, even when the sheet discharging operation and the transportation are simultaneously performed by the sheet discharging roller mechanism 29 and the transportation roller mechanism 19, the sheet transportation speed is set to the transportation speed of the transportation roller mechanism 19. For this reason, accurate and stable sheet transportation without irregularity is performed.

Here, when the sheet P is supported and transported by the high friction layer 50 of the transportation roller 15, torque acts on the roller body 16. Then, a stress acts in a direction of opening the joint 80 (refer to FIG. 4) of the pair of end portions 61a and 61b of the metal sheet forming the roller body 16. When the joint 80 of the roller body 16 is opened, the transportation roller 15 does not uniformly come into contact with the sheet P, which may cause irregularity in the transportation.

However, in the embodiment, the roller body 16 of the transportation roller 15 is formed by the wound-shaped metal sheet of the steel sheet coil, and is formed in a cylindrical shape in which the lower surface C1 as the inner peripheral side of the coil is formed as the inner peripheral surface. The wound shape of the metal sheet of the steel sheet coil is warped so that the lower surface C1 as the inner peripheral surface of the steel sheet coil is formed as a concave surface. That is, the wound shape in which the inner peripheral surface side of the roller body 16 is bent remains in the metal sheet forming the roller body 16.

For this reason, the wound shape does not act at least in a direction of opening the joint 80 of the roller body 16. Accordingly, it may be difficult to open the joint 80 of the roller body 16 compared with the case where the wound shape remains in which the outer peripheral surface side of the roller body 16 is bent. That is, according to the embodiment, even when the stress acts in a direction of opening the joint 80 of the roller body 16, it is possible to provide the transportation roller 15 in which the joint 80 is prevented from being opened, and high transportation precision is obtained.

Further, the circumferential direction (the bending direction) of the roller body 16 is set to be equal to the winding direction (the rolling direction of the metal sheet) of the steel sheet coil. For this reason, the bending direction of the metal sheet forming the roller body 16 can be made to be equal to the warpage direction of the wound shape. Accordingly, the wound shape of the metal sheet forming the roller body 16 acts in a direction of closing the joint 80 of the roller body 16. Accordingly, it is possible to more effectively prevent the joint 80 of the roller body 16 from being opened.

Furthermore, by adopting the hollow cylindrical shaft as the roller body 16, it is possible to remarkably decrease the weight compared with the case where the solid shaft is used. Moreover, a demand for cutting the material is decreased compared with the case where the solid shaft is used as the roller body 16. Accordingly, it is possible to use a material not containing harmful substances such as lead as the material of the roller body 16, and thus to reduce an environmental load.

In addition, the high friction layer 50 is formed on the transportation roller 15, and the driven roller 17 is disposed at a position coming into contact with the high friction layer 50. For this reason, a force pinching the sheet P between the transportation roller 15 and the driven roller 17 becomes large, and hence the transportation performance of the sheet P becomes more satisfactory.

Further, the roller body 16 of the transportation roller 15 has a structure in which in the sectional shape shown in FIG. 5, the thickness Th1 of the joint facing portion 160 facing the joint 80 with the axis O1 interposed therebetween is larger than the thickness Th2 of the joint portion 161 provided with the joint 80, and the thickness of the roller body 16 connecting the joint facing portion 160 and the joint portion 161 is gradually changed as it goes from the joint facing portion 160 to the joint portion 161. For this reason, it is possible to suppress a variation in time of the transportation roller 15 with the elapsing of time, and to maintain the shape having excellent linearity with small warpage in the axial direction and having high circularity for a long period of time.

That is, in the pressing process shown in FIG. 10C, in order to allow the pair of end portions 61a and 61b of the flat portion 60 to come into contact with each other without a gap therebetween, a pressing process is performed in such a manner that the pair of end portions 61a and 61b is aligned to each other, and is crushed in the circumferential direction. Then, the crushing margin escapes in the axial direction of the roller body 16, and the internal stress causing extension in the axial direction is generated in the joint portion 161 provided with the joint 80 shown in FIG. 5. When the internal stress is removed with the elapsing of time, a variation in time occurs in the form of a convex warpage on the side of the joint 80 formed between the pair of facing end portions 61a and 61b.

However, in the sectional shape perpendicular to the axis O1 of the roller body 16, when the thickness Th1 of the joint facing portion 160 is larger than the thickness Th2 of the joint portion 161, the thickness Th2 of the joint portion 161 becomes relatively small. Since the joint portion 161 is a portion where the internal stress causing extension in the axial direction is accumulated, when the thickness Th2 of the joint portion 161 is decreased, it is possible to decrease the internal stress, and to decrease the convex warpage on the side of the joint 80 caused by the extension in the axial direction. Further, even when the joint portion 161 attempts to extend in the axial direction due to the internal stress, since the thickness Th1 of the joint facing portion 160 is relatively large, the deformation can be suppressed. Furthermore, since the thickness is gradually changed from the joint facing portion 160 to the joint portion 161, it is possible to prevent the interference of the power transmission or the occurrence of the stress concentration caused by the local step therebetween, and to prevent the occurrence of the warpage of the roller body 16 and the distortion degrading the circularity caused by the extension in the axial direction due to a variation in time.

Further, when the thickness of the roller body 16 is adjusted as described above, the side of the outer peripheral surface 16a corresponding to the joint portion 161 of the roller body 16 is cut by a predetermined thickness using a milling machine or the like, thereby decreasing the internal stress accumulated in the joint portion 161 during the pressing process (refer to FIG. 11). For this reason, it is possible to further decrease the warpage with the elapsing of time of the transportation roller 15.

Further, a difference between the thickness Th1 of the joint facing portion 160 and the thickness Th2 of the joint portion 161 is set to be equal to or more than 10% and equal to or less than 50% when the thickness Th2 is set to 100%. That is, when a difference in the thickness is less than 10%, since a difference in the thickness between the joint facing portion 160 and the joint portion 161 is small, it is not possible to sufficiently obtain the above-described effect, and it is difficult to prevent the occurrence of the convex warpage on the side of the joint 80 which is the problem of the related art. On the other hand, when a difference in the thickness is larger than 50%, the strength of the joint portion 161 becomes weak, which may cause the distortion that degrades the circularity and generates the warpage of the roller body 16. For this reason, when a difference between the thickness Th1 of the joint facing portion 160 and the thickness Th2 of the joint portion 161 is set to be equal to or more than 10% and equal to or less than 50% when the thickness Th2 is set to 100%, the above-described effect can be sufficiently obtained.

Further, the transportation unit 20 of the embodiment includes the transportation roller 15 and the bearing 26 supporting the transportation roller 15. For this reason, the transportation roller 15 obtaining the above-described high transportation precision can be rotatably supported by the bearing 26, and the sheet P can be transported with high precision by the high friction layer 50. In addition, by adopting the hollow roller body 16 as the transportation roller 15, it is possible to remarkably decrease the weight of the transportation unit 20 and to decrease the environmental load compared with the case where the solid shaft is used. Additionally, since the transportation unit 20 includes the transportation roller 15 having small warpage with the elapsing of time, it is possible to highly precisely transport the sheet P for a long period of time.

Furthermore, the ink jet printer 1 of the embodiment can highly precisely transport the sheet P by the use of the transportation unit 20, and highly precisely perform the printing process on the sheet P for a long period of time. Further, by adopting the hollow roller body 16 as the transportation roller 15, it is possible to remarkably decrease the weight of the entire apparatus and to decrease the environmental load compared with the case where the solid shaft is used.

As described above, according to the embodiment, it is possible to obtain the transportation roller 15 capable of decreasing the warpage with the elapsing of time. Further, it is possible to obtain the transportation unit 20 capable of highly precisely transporting the sheet P for a long period of time. Furthermore, it is possible to obtain the ink jet printer 1 capable of performing the accurate printing process on the sheet P for a long period of time.

Moreover, the technical scope of the invention is not limited to the above-described embodiment, and may be appropriately modified within the scope of the spirit of the invention.

For example, in the above-described embodiment, the roller body 16 is formed by using the steel sheet coil, obtained by winding a metal sheet such as a zinc plating steel sheet or a stainless steel sheet, as a base material, but the invention is not limited thereto. For example, the roller body 16 may be formed in such a manner that a flat metal sheet is used as a base material, the metal sheet substantially having the same shape and dimension as those of the flat portion 60 is formed of the flat metal sheet, and then the metal sheet is processed. Accordingly, for example, in the description above or below, the invention may be applied even when the flat portion 60 is moved to the metal sheet.

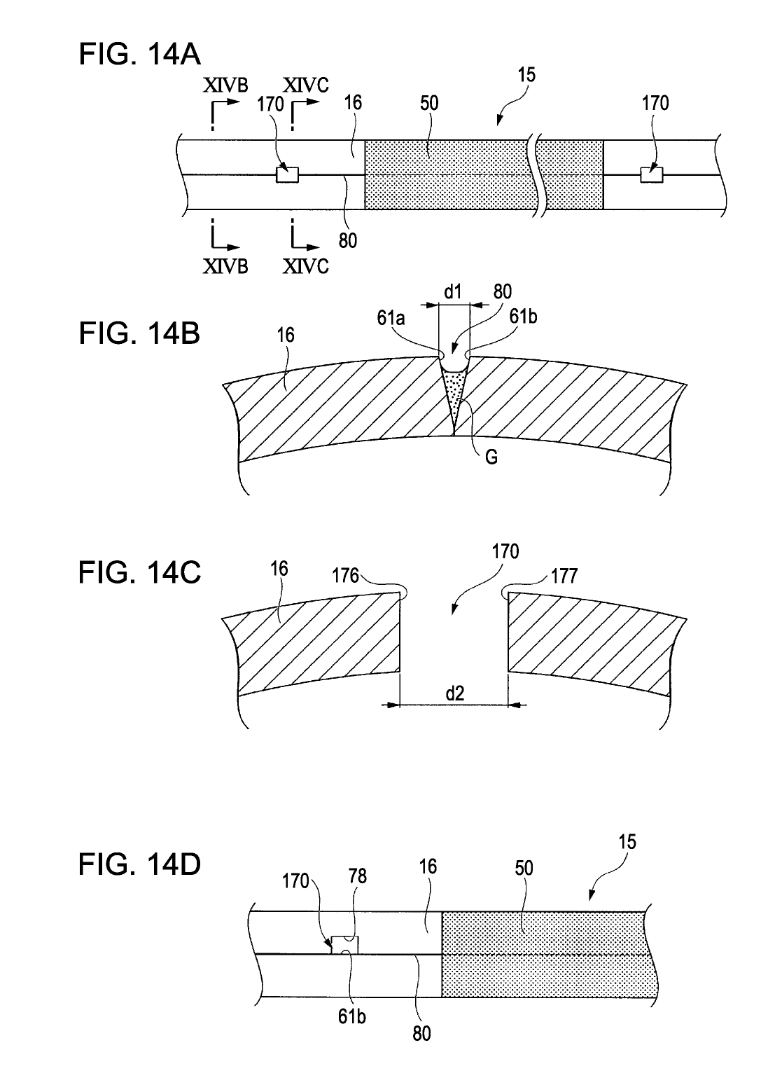

Further, for example, a part of the joint 80 formed in the roller body 16 may be provided with an opening 170 as shown in FIG. 14A.

As shown in FIG. 14B, the joint 80 formed in the roller body 16 is formed as a groove of which the inner peripheries of the pair of end portions 61a and 61b come into close contact with each other, and the outer peripheries are spaced from each other. Alternatively, the joint 80 may be formed as a gap in which the end portions 61a and 61b are slightly spaced from each other while the pair of end portions 61a and 61b does not come into contact with each other. Then, since the joint 80 is formed throughout the entire length of the transportation roller 15, when grease G supplied to the bearing 26 is attached to the surface of the transportation roller 15, the grease G flows along the joint 80 by the capillary phenomenon. Particularly, when the joint 80 (a maximum distance d1 between the end portions 61a and 61b) is decreased in order to improve the strength of the transportation roller 15, the capillary phenomenon of the grease G becomes strong, and the grease G easily flows along the joint 80.

Therefore, as shown in FIG. 14C, a part of the joint 80 formed in the roller body 16 is provided with the opening 170. As shown in FIG. 14C, the opening 170 is formed by notch portions 176 and 177 respectively provided in the pair of end portions 61a and 61b forming the joint 80. Since the maximum distance d2 between the notch portions 176 and 177 is set to about 1 mm or more when the end portions 61a and 61b come into contact with each other, the notch portions serve as the opening 170.

The opening 170 is provided in an area not including the area provided with the high friction layer 50 and the area supported by the bearing 26 among the joint 80 formed throughout the entire length of the transportation roller 15 (the roller body 16). That is, since the high friction layer 50 is substantially formed at the center portion of the transportation roller 15, and both end sides of the transportation roller 15 are supported by the bearing 26, at least two openings 170 are provided in the transportation roller 15.

The opening 170 is provided for the purpose of preventing the grease G (lubricating oil) supplied (applied) to the bearing 26 from reaching the high friction layer 50 along the joint 80 (the gap between the end portions 61a and 61b). That is, since the opening 170 is provided in a part of the joint 80, the capillary phenomenon of the grease G is stopped. Specifically, since the opening 170 is provided between the area supported by the bearing 26 and the area provided with the high friction layer 50 among the joint 80, the grease G is prevented from reaching the high friction layer 50. Then, since the size (the maximum distance d2 between the pair of notch portions 176 and 177) of the opening 170 is adjusted, the capillary phenomenon of the grease G can be reliably stopped.

Further, the invention is not limited to the configuration in which the notch portions 176 and 177 for forming the opening 170 are respectively provided in the pair of end portions 61a and 61b forming the joint 80. That is, as shown in FIG. 14D, a configuration may be adopted in which a notch portion 178 is formed in only one (for example, the end portion 61a) of the pair of end portions 61a and 61b forming the joint 80, and the opening 170 is formed by the notch portion 178 and the end portion 61b. Further, the shape of the opening 170 is not limited to the rectangular shape, but may be a circular shape or the like.

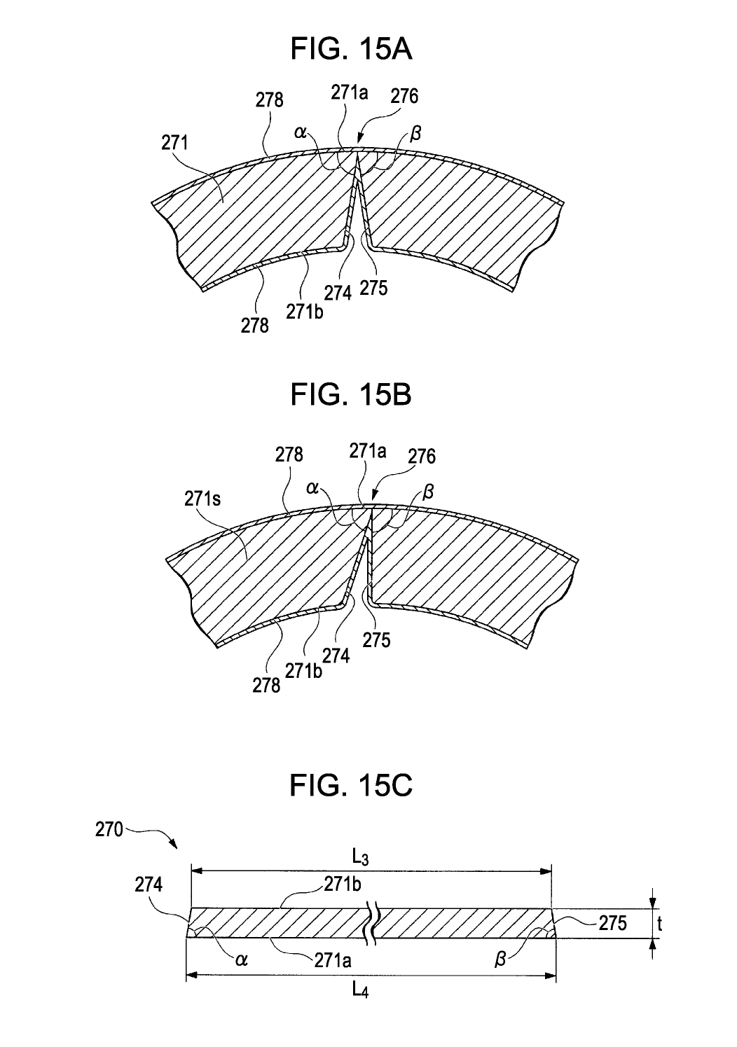

Further, as shown in FIGS. 15A to 15C, the shape of the joint (denoted by the reference numeral 276 in FIGS. 15A to 15C) formed in the roller body (denoted by the reference numeral 271 in FIGS. 15A to 15C) may be the shape shown in FIG. 15A. That is, the joint 276 has a structure in which a first end portion 274 and a second end portion 275 come into contact with each other on the side of an outer peripheral surface 271a of the roller body 271. The gap between the first end portion 274 and the second end portion 275 becomes larger as it goes from the outside of the radial direction to the inside of the radial direction. In addition, the shapes of the first end portion 274 and the second end portion 275 are the same throughout the entire length of the axial direction of the roller body 271.

The roller body 271 has a plating layer 278 formed on the surface thereof. The plating layer 278 is formed on the outer peripheral surface 271a, the inner peripheral surface 271b, and the end surfaces of the first and second end portions 274 and 275. The plating layer 278 may be formed by the use of electroplating or electrodeless plating, and may be formed by laminating a plurality of plating layers. An example of the platings includes nickel plating, zinc plating, or chromium plating.

Further, a first angle α formed by the first end portion 274 and the outer peripheral surface 271a and a second angle β formed by the second end portion 275 and the outer peripheral surface 271a are set to be smaller than 90°.

The first end portion 274 and the second end portion 275 of the joint 276 are connected to each other on the side of the outer peripheral surface 271a, and the smoothness on the side of the outer peripheral surface 271a of the connection portion is improved. For this reason, even when the transportation roller 15 is rotated, the outer peripheral surface stably comes into contact with the sheet P. Therefore, it is possible to highly precisely transport the sheet P.

In the shape of the joint 276, as shown in FIG. 15B, the first angle α formed by the outer peripheral surface 271a and the first end portion 274 of the joint 276 may be set to be smaller than 90°, and the second angle β formed by the outer peripheral surface 271a and the second end portion 275 may be set to be larger than 90°. That is, the first end portion 274 and the second end portion 275 in the connection portion of the joint 276 may have a shape inclined to a predetermined direction with respect to the circumferential direction.

Further, the shape of the joint 276 is formed by the following procedures. That is, after a metal sheet 270 is formed by the punching process in the forward pressing process, the first end portion 274 and the second end portion 275 of the metal sheet 270 are processed to adjust the end portions, and the inclinations of the first end portion 274 and the second end portion 275 with respect to the outer peripheral surface 271a are adjusted.

As shown in FIG. 15C, the angles of the first end portion 274 and the second end portion 275 with respect to the outer peripheral surface 271a are adjusted by a pressing process. Due to the adjustment, the first angle α formed by the first end portion 274 and the outer peripheral surface 271a and the second angle β formed by the second end portion 275 and the outer peripheral surface 271a become smaller than 90°. In addition, in the metal sheet 270 having a sheet thickness t, the length L₃ on the side formed as the inner peripheral surface 271b becomes smaller than the length L₄ on the side formed as the outer peripheral surface 271a.

Accordingly, when the cylindrical roller body 271 is formed by bending the metal sheet 270, the first end portion 274 and the second end portion 275 are connected to each other at least on the side of the outer peripheral surface 271a.

Further, in FIGS. 15A to 15C, when the first end portion 274 and the second end portion 275 are formed in a taper shape having a predetermined angle by performing a pressing process as the end portion adjusting process, the internal stress is accumulated in the first end portion 274 and the second end portion 275. When the end portions face each other, the internal stress causing extension in the axial direction occurs in the joint portion provided with the joint 276. However, as described above, when the thickness of the joint facing portion is larger than that of the joint portion provided with the joint 276, and the thickness is gradually changed, it is possible to suppress a variation in time by the same effect as that of the above-described embodiment.

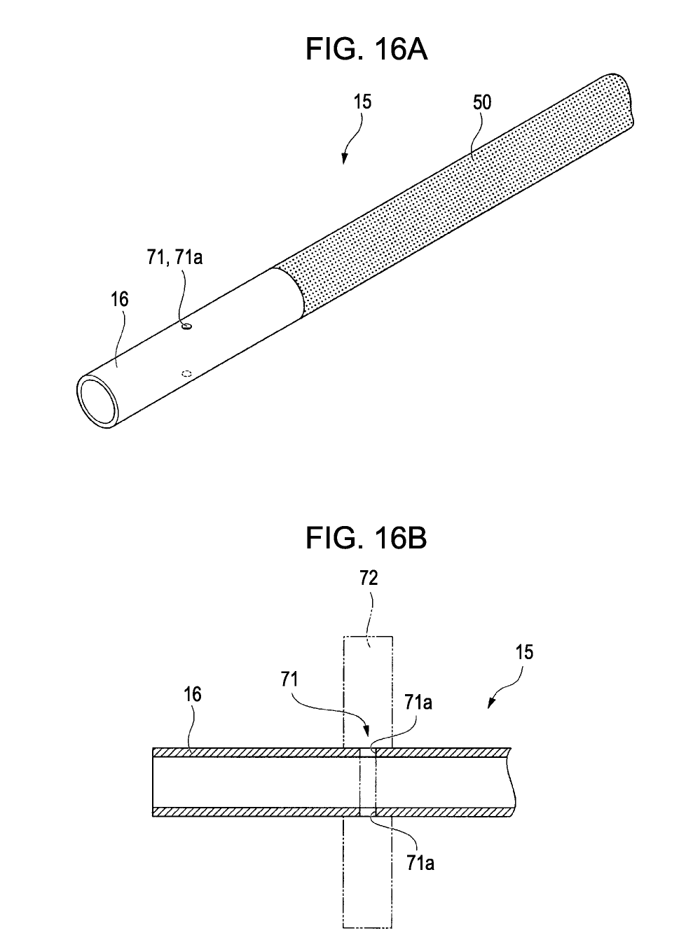

Further, as described above, one or both end portions of the roller body 16 (the transportation roller 15) is provided with the engagement portion that is used to connect various connection components such as the transportation driving gear 35 or the inner gear 39 shown in FIG. 2. For example, as shown in FIGS. 16A and 16B, perforation holes 71a are respectively formed at the facing positions, that is, two points stipulating the diameter of the roller body 16 of the roller body 16 formed as the cylindrical pipe (hollow pipe), and an engagement hole (engagement portion) 71 including the pair of perforation holes 71a can be formed. According to the engagement hole 71, it is possible to fix the connection component 72 such as a gear by the use of a shaft or pin (not shown).

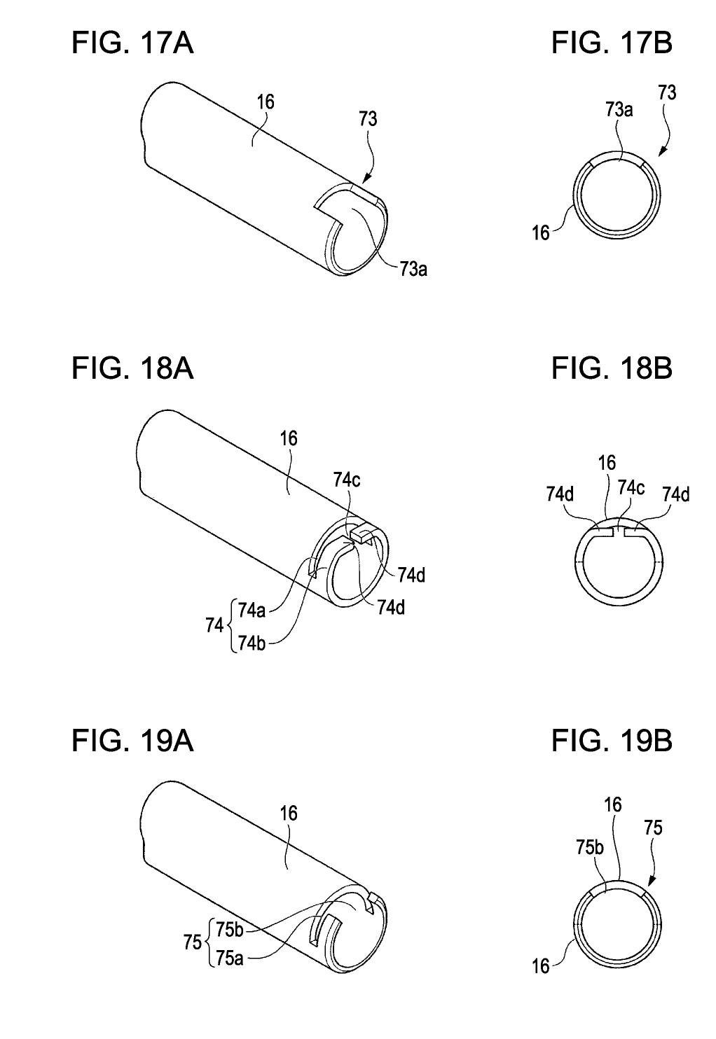

Further, as shown in FIGS. 17A and 17B, a D-cut-shaped engagement portion 73 may be formed in the end portion of the roller body 16. The engagement portion 73 is formed in the end portion of the cylindrical hollow pipe (the roller body 16), and includes an opening 73a of which a part is cut in a rectangular shape in a plan view as shown in FIG. 17A. Accordingly, as shown in FIG. 17B, the external shape of the side surface of the end portion is formed as a D-shape.

Accordingly, when a connection component (not shown) such as a gear engages with the engagement portion 73 having a D-shaped external shape, it is possible to attach the connection component to the roller body 16 (the transportation roller 15) without idle rotation. In addition, since a groove-shaped opening 73a communicating with the inner hole of the hollow pipe (roller body 16) is formed in the engagement portion 73, it is possible to attach the connection component to the roller body 16 without idle rotation by the use of the opening 73a. Specifically, a convex portion is formed in the connection component, and the convex portion engages with the opening 73a, thereby preventing the idle rotation.

Furthermore, as shown in FIGS. 18A and 18B, an engagement portion 74 having a groove 74a and a D-cut portion 74b may be formed in the end portion of the roller body 16. In the engagement portion 74, the D-cut portion 74b is formed in the outer end of the roller body 16, and the groove 74a is formed on the inside of the D-cut portion 74b. As shown in FIG. 18A, the groove 74a is formed by cutting substantially half of the roller body 16 in the circumferential direction. The D-cut portion 74b includes an opening 74c that extends in a direction perpendicular to the groove 74a on the outside of the groove 74a, and includes a pair of bent pieces 74d formed on both sides of the opening 74c. That is, as shown in FIG. 18B, the pair of bent pieces 74d is bent toward the axis of the roller body 16, and hence the portions corresponding to the bent pieces 74d are depressed from the circular outer peripheral surface of the roller body 16.

Accordingly, when a connection component (not shown) such as a gear engages with the groove 74a or the D-cut portion 74b, it is possible to attach the connection component to the roller body 16 (the transportation roller 15) without idle rotation. In addition, it is possible to attach the connection component to the roller body 16 without idle rotation by the use of the opening 74c formed between the bent pieces 74d in the engagement portion 74. Specifically, a convex portion is formed in the connection component, and the convex portion engages with the opening 74c, thereby preventing the idle rotation.

Further, as shown in FIGS. 19A and 19B, an engagement portion 75 having a groove 75a and an opening 75b may be formed in the end portion of the roller body 16. In the engagement portion 75, the opening 75b is formed in the outer end of the roller body 16, and the groove 75a is formed on the inside of the opening 75b. As shown in FIG. 19A, the groove 75a is formed by cutting substantially half of the roller body 16 in the circumferential direction. The opening 75b has a structure in which a part of the roller body 16 on the outside of the groove 75a is cut in a rectangular shape in a plan view. Accordingly, as shown in FIG. 19B, the external shape of the side surface of the end portion is formed as a D-shape.

Accordingly, when a connection component (not shown) such as a gear engages with the groove 75a or a portion having a D-shaped external shape by the opening 75b, it is possible to attach the connection component to the roller body 16 (the transportation roller 15) without idle rotation. Further, even in the engagement portion 75, it is possible to attach the connection component to the roller body 16 without idle rotation by the use of the opening 75b as in the engagement portion 73 shown in FIGS. 17A and 17B.

The engagement hole 71 or the engagement portions 73, 74, and 75 can be formed by performing a cutting process or the like on the roller body 16 having the flat portion 60 obtained by performing a pressing process. However, in this case, since a separate processing procedure is added only for the purpose of forming the engagement portion in the roller body 16, the efficiency in cost or time is degraded. Therefore, in the manufacturing method of the invention, a development engagement portion formed as an engagement portion by a pressing process of the first pressing procedure is formed in the flat portion 60 before performing a pressing process on the roller body 16 in the second pressing procedure, and then the engagement portion is simultaneously formed when performing a pressing process on the flat portion 60 to obtain the roller body 16 in the second pressing procedure.

Specifically, when a punching process is performed on the metal sheet M wound in a coil shape to obtain the flat portion 60 which is thin and long and has a substantially rectangular sheet shape, the development engagement portion having a notch shape, a protrusion shape, a hole shape, or a groove shape is formed in the end portion of the flat portion 60 at the same time when processing the large metal sheet M into the small flat portion 60.

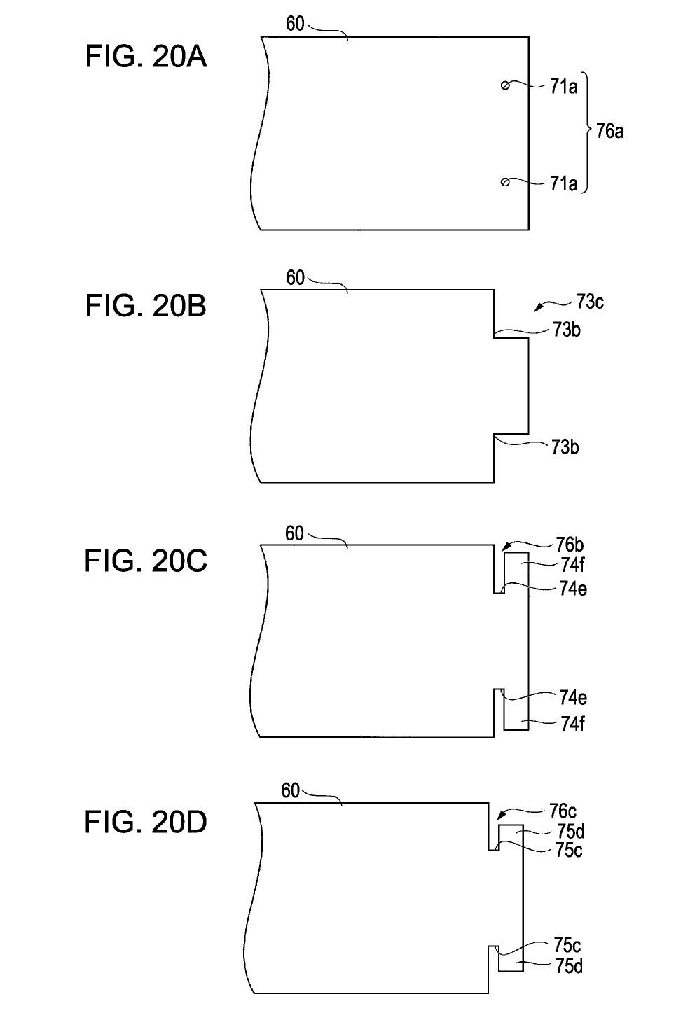

For example, as shown in FIG. 20A, a development engagement portion 76a is formed by processing a pair of perforation holes 71a in a predetermined position of the end portion of the flat portion 60. Then, a pressing process is performed on the flat portion 60 so that the perforation holes 71a face each other, thereby forming the engagement hole 71 shown in FIGS. 16A and 16B.

Further, as shown in FIG. 20B, a development engagement portion 73c having a pair of notch portions 73b is formed by cutting the end portion of the flat portion 60 in a predetermined shape, and then a pressing process is performed on the flat portion 60, thereby forming the engagement portion 73 shown in FIGS. 17A and 17B.

Furthermore, as shown in FIG. 20C, a development engagement portion 76b is formed by cutting the end portion of the flat portion 60 in a predetermined shape. Then, a pressing process is performed on the flat portion 60, thereby forming the engagement portion 74 shown in FIGS. 18A and 18B. That is, it is possible to form the engagement portion 74 by forming a pair of protrusions 74f and a pair of notch portions (concave portions) 74e as the development engagement portion 76b. However, in this example, since it is necessary to form the bent piece 74d by bending the pair of protrusions 74f inward after performing a pressing process on the flat portion 60, it is slightly insufficient to improve the efficiency in the cost or time for the processing procedure.

Therefore, as shown in FIG. 20D, a development engagement portion 76c is formed by cutting the end portion of the flat portion 60 in a predetermined shape. Then, a pressing process is performed on the flat portion 60, thereby forming the engagement portion 75 shown in FIGS. 19A and 19B. That is, it is possible to form the engagement portion 75 by forming a pair of protrusions 75d and a pair of notch portions (concave portions) 75c as the development engagement portion 76c. In this example, it is possible to form the opening 75b shown in FIG. 19B between the protrusions 75d by bending the pair of protrusions 75d in a circular-arc shape when performing a pressing process on the flat portion 60. Accordingly, since it is not necessary to add another processing for the roller body 16 formed by the pressing process, it is possible to sufficiently improve the efficiency in the cost or time for the processing.

Here, in the examples shown in FIGS. 20B to 20D, the development engagement portions 73c, 76b, and 76c are formed in both end portions of the flat portion 60 so that the engagement portions 73, 74, and 75 shown in FIGS. 17A, 17B, 18A, 18B, 19A, and 19B are formed with the joint 80 interposed therebetween. Likewise, it is possible to allow the joint 80 of the roller body 16 to be shorter than the roller body 16 by forming the development engagement portions 73c, 76b, and 76c in both end portions of the flat portion. Accordingly, it is possible to suppress the deformation of the roller body 16 due to the interference of the partial contact between the end portions 61a and 61b when forming the joint 80.

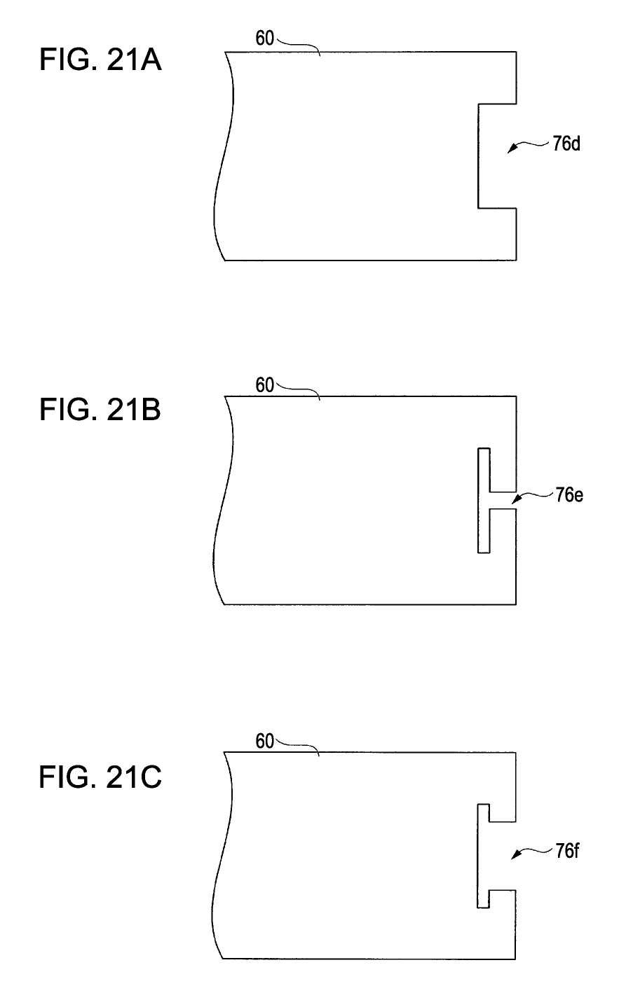

However, the invention is not limited to the above-described configuration. As shown in FIGS. 21A to 21C, the engagement portion can be formed in the vicinity of the axis in the width direction (bending direction) without forming the development engagement portion in both end portions of the flat portion 60. That is, the engagement portion 73 shown in FIGS. 17A and 17B can be formed by forming the development engagement portion 76d, formed by a notch which is thin and long and has a rectangular shape, in the end portion, as shown in FIG. 21A. Further, it is possible to form the engagement portion 74 shown in FIGS. 18A and 18B by forming the development engagement portion 76e formed by the T-shaped notch shown in FIG. 21B. Furthermore, it is possible to form the engagement portion 75 shown in FIGS. 19A and 19B by forming the development engagement portion 76f formed by the substantially T-shaped notch shown in FIG. 21C.

Likewise, when the development engagement portions 76d to 76f are formed in the vicinity of the axis in the bending direction, it is possible to more highly precisely form the engagement portions 73 to 75 obtained from the development engagement portions 76d to 76f.

As described above, in the method of manufacturing the transportation roller 15, the development engagement portion is formed at the same time when forming the small metal sheet (flat portion 60) from the large metal sheet M by a pressing process. Further, the engagement hole (engagement portion) 71, and the engagement portions 73, 74, and 75 are formed from the development engagement portion when performing a pressing process on the flat portion 60. Accordingly, it is not necessary to add another processing procedure only for the purpose of forming the engagement portion after forming the roller body 16.

Accordingly, since a cost or time for the added processing procedure is not required, the transportation roller 15 can be sufficiently decreased in cost, and the productivity is improved. In particular, since the development engagement portion is simultaneously formed when decreasing the size of the large metal sheet, it is possible to further simplify the processing procedures.

Further, as shown in FIG. 4, in the transportation roller 15 (the roller body 16) according to the embodiment, the joint 80 is formed to be parallel to the axis of the roller body 16 formed as the cylindrical hollow pipe, but the invention is not limited thereto.

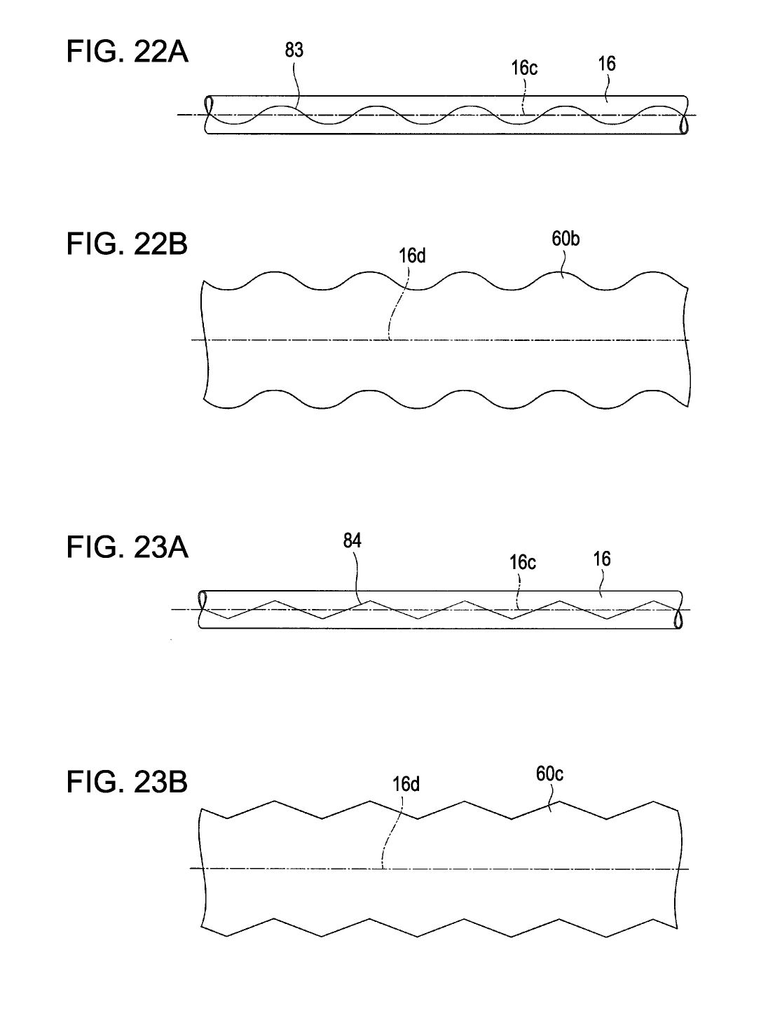

For example, as shown in FIG. 22A, a joint 83 may be formed in a wavy line shape formed as a curve such as a sine wave. In order to form the joint 83 in this way, a flat portion 60b, which is thin and long and has a substantially rectangular shape and of which both long sides are formed in a wavy line shape shown in FIG. 22B, is used as the metal sheet as the base material, and then a pressing process is performed so that the line indicated by the reference numeral 16d is aligned to the axis. Further, since the pair of long sides having a wavy line shape comes closer to each other by a pressing process, the corresponding portions are, of course, formed in such a manner that one long side is formed as a peak portion and the other long side is formed as a valley portion, and vice versa.

Furthermore, as shown in FIG. 23A, a joint 84 may be formed in a wavy line shape bent in a hook shape. In order to form the joint 84 in this way, a flat portion 60c, which is thin and long and has a substantially rectangular shape and of which both long sides are formed in a wavy line shape bent in a hook shape shown in FIG. 23B, is used as the metal sheet as the base material, and then a pressing process is performed so that the line indicated by the reference numeral 16d is aligned to the axis. Even in the flat portion 60c, the corresponding portions of the pair of long sides formed in a wavy line shape are formed in such a manner that one long side is formed as a peak portion and the other long side is formed as a valley portion, and vice versa.

Further, the joint is not limited to the examples shown in FIGS. 22A, 22B, 23A, and 23B, but may be formed in various shapes. For example, the wavy line formed by the curve shown in FIG. 22A may be combined with the bent wavy line shown in FIG. 23A.

Likewise, in the state where the joints 83 and 84 are formed to overlap with each other only at a plurality of points in the line parallel to the axis of the cylindrical pipe (the roller body 16), when the transportation roller 15 having the roller body 16 transports the sheet P together with the driven roller 17, the transportation speed of the sheet P becomes constant, and hence the irregularity in the transportation is further reliably prevented.

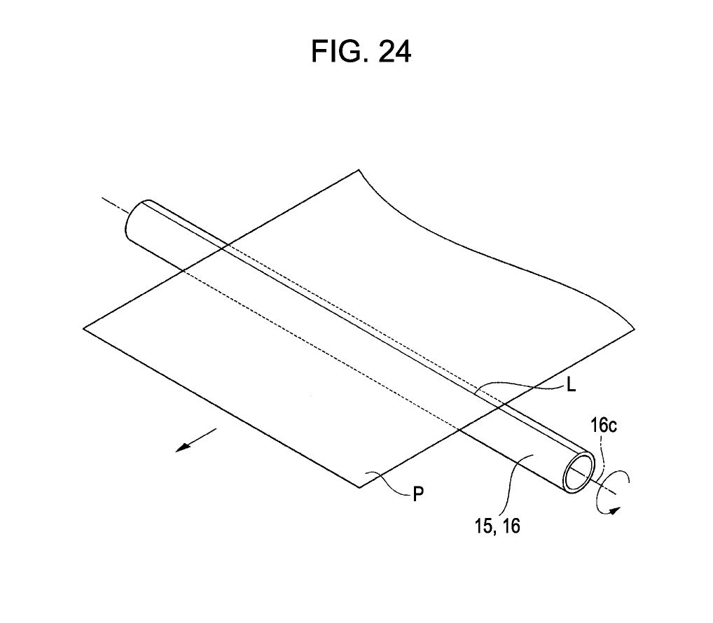

That is, as shown in FIG. 24, the portion contacting the sheet P during the sheet transportation using the transportation roller 15 basically becomes the line L on the outer peripheral surface, that is, the line L parallel to the axis 16C. Accordingly, as shown in FIG. 4, when the joint 80 of the transportation roller 15 (the roller body 16) is parallel to the axis 16c of the roller body 16, the entire joint 80 of the transportation roller 15 temporally comes into contact with the sheet P. Then, as described above, since the transportation roller 15 of the embodiment is not provided with a groove formed by the joint 80, no problem arises. However, when a groove is formed by the joint 80, the groove temporarily and simultaneously comes into contact with the sheet P, and hence the entire width of the sheet P comes into contact with the groove formed by the joint 80. As a result, the transportation speed of the sheet P is temporarily decreased, and the irregularity in the transportation occurs due to the reasons that the groove is provided with a recess compared with the other outer peripheral surface of the transportation roller 15, and the contact resistance with respect to the sheet P is small.

However, if the joints 83 and 84 are formed as shown in FIGS. 22A and 23A, even when a groove is formed by the joints, the portion where the groove contacts the sheet P during the sheet transportation is only a plurality of points. Accordingly, a variation in the contact resistance hardly occurs compared with the case where the other surface of the transportation roller 15 contacts the sheet. Therefore, the transportation speed of the sheet P becomes constant, and the irregularity in the transportation is prevented.

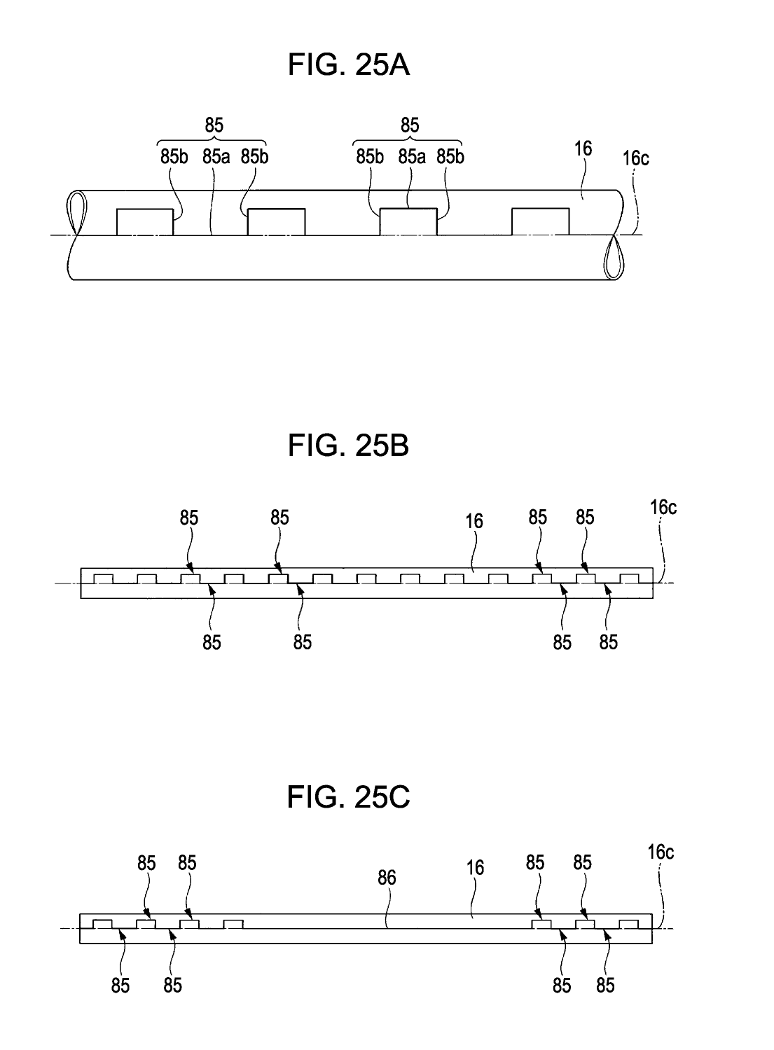

Further, in addition to the above-described example, for example, as shown in FIG. 25A, the joint of the transportation roller 15 (the roller body 16) formed as the cylindrical hollow pipe may be formed by a rectangular wavy-line-shaped bent portion 85 including a linear portion 85a parallel to the axis of the roller body 16 and a linear portion 85b perpendicular thereto. Even in the joint formed by the bent portion 85, even when a groove is formed by the joint, the groove does not simultaneously come into contact with the entire width of the sheet P during the sheet transportation. Therefore, the transportation speed of the sheet P substantially becomes constant, and the irregularity in the transportation is prevented.

Furthermore, the bent portion 85 may be formed throughout the entire length of the roller body 16 as shown in FIG. 25B, or may be selectively formed in both end portions except for the center portion as shown in FIG. 25C. When the bent portion 85 is formed only in both end portions as shown in FIG. 25C, a center linear portion 86 is formed between the bent portions 85 so as to be parallel to the axis of the roller body 16.

Moreover, likewise, when the bent portion 85 is formed only in both end portions, and the center linear portion 86 is formed therebetween, it is desirable that the formation area of the high friction layer 50 shown in FIG. 3 corresponds to the center linear portion 86.

When the bent portion 85 is formed in the joint, and the bent portion 85 is formed as a fitting portion using unevenness, it is difficult to perform the fitting operation in the bent portion 85 (the fitting portion) in accordance with the design, and also it is difficult to allow the front end of the convex portion to be close to (come into contact with) the corresponding concave without a gap therebetween. Accordingly, when the bent portion 85 is formed throughout the entire length of the roller body 16, distortion or torsion easily occurs in the roller body 16. Therefore, when the bent portion 85 is formed only in both end portions as shown in FIG. 25C, it is possible to prevent the occurrence of the distortion or torsion. Further, since particularly the center portion corresponding to the high friction layer 50 as an area directly contacting the sheet p is formed as the center linear portion 86 instead of the bent portion 85, it is possible to reliably prevent the distortion or torsion from occurring in the area directly contacting the sheet P.

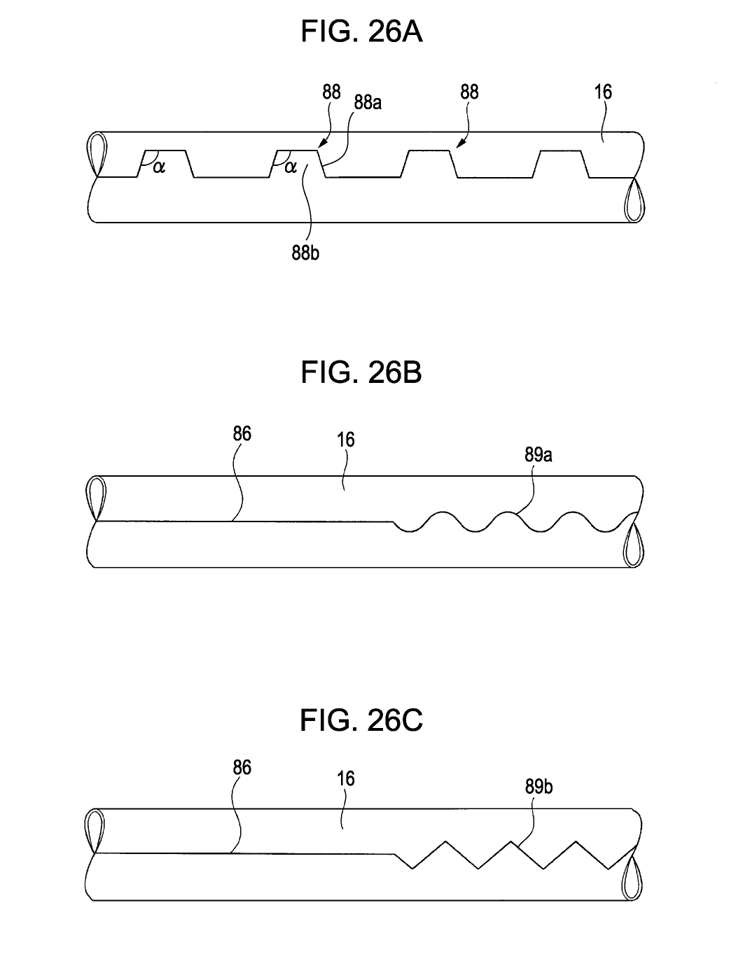

Further, in addition to the above-described example, the joint of the transportation roller 15 (the roller body 16) formed as the cylindrical hollow pipe may have a structure in which an intersection portion 88a of a bent portion 88 shown in FIG. 26A may be not parallel to the axis of the roller body 16, and an angle α in a convex portion 88b of the bent portion 88 may be an obtuse angle (less than 180°). Accordingly, when the pair of end portions comes close to each other by the pressing process of the metal sheet, it is possible to easily fit the front end of the convex portion 88b to the corresponding concave portion, and thus to suppress the occurrence of the distortion or torsion in the roller body 16.

Furthermore, in the structure in which the bent portion 85 is formed only in both end portions as shown in FIG. 25C, the bent portion 85 may be changed to a wavy line 89a formed by a curve shown in FIG. 22A, for example, as shown in FIG. 26B. In addition, the bent portion 85 may be changed to a bent wavy line 89b shown in FIG. 23A as shown in FIG. 26C.

Moreover, the joint may be formed by a combination between the rectangular wavy-line-shaped bent portion 85 shown in FIG. 25A and the wavy line 89a formed by the curve shown in FIG. 26B, or the joint may be formed by a combination between the rectangular wavy-line-shaped portion 85 and the bent wavy line 89b shown in FIG. 26C.

Further, in FIGS. 22A, 22B, 23A, 23B, 25A, 25B, 25C, 26A, 26B, and 26C, when a concave portion and a convex portion are respectively formed in the pair of end portions of the metal sheet, and the pair of end portions faces and is press-inserted to each other, the internal stress causing extension in the axial direction occurs in the joint portion. However, as described above, since the thickness of the joint facing portion is larger than that of the joint portion provided with the joint, and the thickness is gradually changed, it is possible to suppress a variation in time by the same effect as that of the above-described embodiment.

What is claimed is:

1. A transportation roller comprising:
a cylindrical shaft which is formed in a cylindrical shape by subjecting a metal sheet to a pressing process and allowing a pair of end portions thereof to face each other, and has a joint formed between the pair of end portions,
wherein in a sectional shape perpendicular to the axis of the cylindrical shaft, a thickness of a joint facing portion facing the joint with the axis interposed therebetween is larger than a thickness of a joint portion provided with the joint, and a thickness of the cylindrical shaft connecting the joint facing portion and the joint portion is gradually changed as it goes from the joint facing portion to the joint portion.

2. The transportation roller according to claim 1, wherein in the sectional shape, the outer diameter shape of the cylindrical shaft is a circular shape about the axis, and the inner diameter shape of the cylindrical shaft is a circular shape deviating from the axis to the joint portion.

3. A transportation unit comprising:
a transportation roller including:
a cylindrical shaft which is formed in a cylindrical shape by subjecting a metal sheet to a pressing process and allowing a pair of end portions thereof to face each other, and has a joint formed between the pair of end portions,
wherein in a sectional shape perpendicular to the axis of the cylindrical shaft, a thickness of a joint facing portion facing the joint with the axis interposed therebetween is larger than a thickness of a joint portion provided with the joint, and a thickness of the cylindrical shaft connecting the joint facing portion and the joint portion is gradually changed as it goes from the joint facing portion to the joint portion; and
a driving device which rotationally drives the transportation roller.

4. The transportation unit according to claim 3, wherein in the sectional shape, the outer diameter shape of the cylindrical shaft is a circular shape about the axis, and the inner diameter shape of the cylindrical shaft is a circular shape deviating from the axis to the joint portion.

5. A printing apparatus comprising:
the transportation unit according to claim 3; and
a printing unit which performs a printing process on a printing medium transported by the transportation unit.

6. A printing apparatus comprising:
the transportation unit according to claim 4; and
a printing unit which performs a printing process on a printing medium transported by the transportation unit.

7. A method of manufacturing a transportation roller including a cylindrical shaft which is formed in a cylindrical shape by subjecting a metal sheet to a pressing process and allowing a pair of end portions thereof to face each other, and has a joint formed between the pair of end portions, the method comprising:
adjusting a thickness so that in a sectional shape perpendicular to the axis of the cylindrical shaft, a thickness of a joint facing portion facing the joint with the axis interposed therebetween is larger than a thickness of a joint portion provided with the joint, and a thickness of the cylindrical shaft connecting the joint facing portion and the joint portion is gradually changed as it goes from the joint facing portion to the joint portion.

8. The method according to claim 7,
wherein in the adjusting of the thickness, the cylindrical shaft is formed by subjecting the metal sheet having a predetermined sheet thickness to the pressing process and allowing the pair of end portions thereof to face each other, and the joint is formed between the pair of end portions, and
wherein the method further comprises:
cutting the outer peripheral surface of the cylindrical shaft on the side of the joint portion by the predetermined thickness in accordance with a difference between the thickness of the joint facing portion and the thickness of the joint portion; and
grinding the outer peripheral surface of the cut cylindrical shaft.
